(19) United States
(12) Patent Application Publication
(10) Pub. No.: US 2024/0323892 A1
(43) Pub. Date: Sep. 26, 2024

(54) SIDELINK POSITIONING WITH COLLINEAR ANCHORS

(71) Applicant: QUALCOMM Incorporated, San Diego, CA (US)

(72) Inventors: Shuanshuan WU, San Diego, CA (US); Shailesh PATIL, San Diego, CA (US); Kapil GULATI, Belle Mead, NJ (US)

(21) Appl. No.: 18/189,462

(22) Filed: Mar. 24, 2023

(51) Int. Cl. H04W 64/00; H04W 24/10

(52) U.S. Cl. CPC H04W 64/00; H04W 24/10

(57) ABSTRACT

Techniques for sidelink positioning with collinear anchors are disclosed. The techniques can include selecting a set of anchor user equipments (UEs) for a sidelink positioning of a target UE, determining that the set of anchor UEs is collinear, and responsive to the determination that the set of anchor UEs is collinear, initiating a collinear anchor positioning procedure including determining an estimated location of the target UE based on positioning measurements associated with the set of anchor UEs, generating a location report including the estimated location of the target UE, wherein the location report includes an indication that the estimated location is based on collinear anchor positioning measurements, and providing the location report to a location requesting entity.

### BACKGROUND

### 1. Field of Disclosure

The present disclosure relates generally to the field of wireless communications, and more specifically to determining the location of a user equipment (UE) using radio frequency (RF) signals.

### 2. Description of Related Art

Using a sidelink positioning procedure, a location of a UE (the “target UE”) can be estimated with assistance from a set of other UEs (the “anchor UEs”), the locations of which are known. According to the sidelink positioning procedure, the target UE may generate positioning measurements by measuring signals (which may be positioning reference signals or signals of other type(s)) transmitted by the anchor UEs. Additionally or alternatively, the anchor UEs may generate positioning measurements by measuring signals transmitted by the target UE. The location of the target UE can be estimated based on the positioning measurements generated by the target UE, the anchor UEs, or both, by applying any of various types of positioning algorithms.

### BRIEF SUMMARY

An example sidelink positioning method, according to this disclosure, may include selecting a set of anchor user equipments (UEs) for a sidelink positioning of a target UE, determining that the set of anchor UEs is collinear, and responsive to the determination that the set of anchor UEs is collinear, initiating a collinear anchor positioning procedure including determining an estimated location of the target UE based on positioning measurements associated with the set of anchor UEs, generating a location report including the estimated location of the target UE, wherein the location report includes an indication that the estimated location is based on collinear anchor positioning measurements, and providing the location report to a location requesting entity.

An example apparatus for sidelink positioning, according to this disclosure, may include at least one processor and at least one memory communicatively coupled with the at least one processor and storing processor-readable code that, when executed by the at least one processor, is configured to select a set of anchor user equipments (UEs) for a sidelink positioning of a target UE, determine that the set of anchor UEs is collinear, and responsive to the determination that the set of anchor UEs is collinear, initiate a collinear anchor positioning procedure including determining an estimated location of the target UE based on positioning measurements associated with the set of anchor UEs, generating a location report including the estimated location of the target UE, wherein the location report includes an indication that the estimated location is based on collinear anchor positioning measurements, and providing the location report to a location requesting entity.

An example apparatus for sidelink positioning, according to this disclosure, may include means for selecting a set of anchor user equipments (UEs) for a sidelink positioning of a target UE, means for determining that the set of anchor UEs is collinear, and means for initiating a collinear anchor positioning procedure responsive to the determination that the set of anchor UEs is collinear, the collinear anchor positioning procedure including determining an estimated location of the target UE based on positioning measurements associated with the set of anchor UEs, generating a location report including the estimated location of the target UE, wherein the location report includes an indication that the estimated location is based on collinear anchor positioning measurements, and providing the location report to a location requesting entity.

An example non-transitory computer-readable medium, according to this disclosure, may store instructions for sidelink positioning, and the instructions may include code to select a set of anchor user equipments (UEs) for a sidelink positioning of a target UE, determine that the set of anchor UEs is collinear, and responsive to the determination that the set of anchor UEs is collinear, initiate a collinear anchor positioning procedure including determining an estimated location of the target UE based on positioning measurements associated with the set of anchor UEs, generating a location report including the estimated location of the target UE, where the location report includes an indication that the estimated location is based on collinear anchor positioning measurements, and providing the location report to a location requesting entity.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

FIG. 1 is a diagram of a positioning system, according to an embodiment.

FIG. 2 is a diagram of a 5th Generation (5G) New Radio (NR) positioning system, illustrating an embodiment of a positioning system (e.g., the positioning system of FIG. 1) implemented within a 5G NR communication network.

FIGS. 3A-3C are simplified diagrams of scenarios in which sidelink positioning may be used to determine the position of a target user equipment (UE).

FIG. 4 is a diagram showing an example of a frame structure for NR and associated terminology.

FIG. 5 is a diagram showing an example of a radio frame sequence with Positioning Reference Signal (PRS) positioning occasions.

FIG. 6 is a diagram showing example combination (comb) structures, illustrating how RF signals may utilize different sets of resource elements, according to some embodiments.

FIG. 7 is a diagram illustrating an example resource pool for positioning within a sidelink resource pool, according to aspects of the disclosure.

FIG. 8 is a block diagram illustrating a first example operating environment, according to aspects of the disclosure.

FIG. 9 is a block diagram illustrating a second example operating environment, according to aspects of the disclosure.

FIG. 10 is a block diagram illustrating a third example operating environment, according to aspects of the disclosure.

FIG. 11 illustrates an example sidelink positioning method, according to aspects of the disclosure.

FIG. 12 is a block diagram of an embodiment of a UE, which can be utilized in embodiments as described herein.

FIG. 13 is a block diagram of an embodiment of a computer system, which can be utilized in embodiments as described herein.

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3 etc. or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c).

### DETAILED DESCRIPTION

The following description is directed to certain implementations for the purposes of describing innovative aspects of various embodiments. However, a person having ordinary skill in the art will readily recognize that the teachings herein can be applied in a multitude of different ways. The described implementations may be implemented in any device, system, or network that is capable of transmitting and receiving radio frequency (RF) signals according to any communication standard, such as any of the Institute of Electrical and Electronics Engineers (IEEE) 802.15.4 standards for ultra-wideband (UWB), IEEE 802.11 standards (including those identified as Wi-Fi® technologies), the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Rate Packet Data (HRPD), High Speed Packet Access (HSPA), High Speed Downlink Packet Access (HSDPA), High Speed Uplink Packet Access (HSUPA), Evolved High Speed Packet Access (HSPA+), Long Term Evolution (LTE), Advanced Mobile Phone System (AMPS), or other known signals that are used to communicate within a wireless, cellular or internet of things (IoT) network, such as a system utilizing 3G, 4G, 5G, 6G, or further implementations thereof, technology.

As used herein, an “RF signal” comprises an electromagnetic wave that transports information through the space between a transmitter (or transmitting device) and a receiver (or receiving device). As used herein, a transmitter may transmit a single “RF signal” or multiple “RF signals” to a receiver. However, the receiver may receive multiple “RF signals” corresponding to each transmitted RF signal due to the propagation characteristics of RF signals through multiple channels or paths.

Additionally, unless otherwise specified, references to “reference signals,” “positioning reference signals,” “reference signals for positioning,” and the like may be used to refer to signals used for positioning of a user equipment (UE). As described in more detail herein, such signals may comprise any of a variety of signal types but may not necessarily be limited to a Positioning Reference Signal (PRS) as defined in relevant wireless standards.

Further, unless otherwise specified, the term “positioning” as used herein may absolute location determination, relative location determination, ranging, or a combination thereof. Such positioning may include and/or be based on timing, angular, phase, or power measurements, or a combination thereof (which may include RF sensing measurements) for the purpose of location or sensing services.

Various aspects relate generally to wireless communications, and more particularly to determining the location of a UE using RF signals. Some aspects more specifically relate to estimating a location of a UE via sidelink positioning with collinear anchors. According to various aspects, when a set of anchor UEs is selected for sidelink positioning of a target UE, a determination can be made of whether the set of anchor UEs is collinear. In some implementations, a collinearity metric value associated with the set of anchor UEs can be determined based on the respective locations of the anchor UEs, and can be compared to a threshold to determine whether the set of anchor UEs is collinear. In various implementations, if the set of anchor UEs is collinear, estimation and/or reporting of the target UE's location can be adapted to mitigate impairment that the collinearity of the anchor UEs may tend to impose upon the accuracy of sidelink positioning. In some implementations, the accuracy of sidelink positioning involving collinear anchor UEs can be improved using supplemental positioning measurements, other supplemental information, or both. In some implementations, location estimates obtained via sidelink positioning involving collinear anchor UEs can be conveyed in such a way as to notify location requesting entities (also referred to herein as location consumers) of the collinearity of the anchor UEs involved. In various implementations, location estimates obtained via sidelink positioning involving collinear anchor UEs can be conveyed in location reports that include indications of uncertainties attributable to the collinearity of the anchor UEs. According to aspects of the disclosure, implementing one or more such techniques can enable location requesting entities (location consumers) to obtain more accurate knowledge of UE locations.

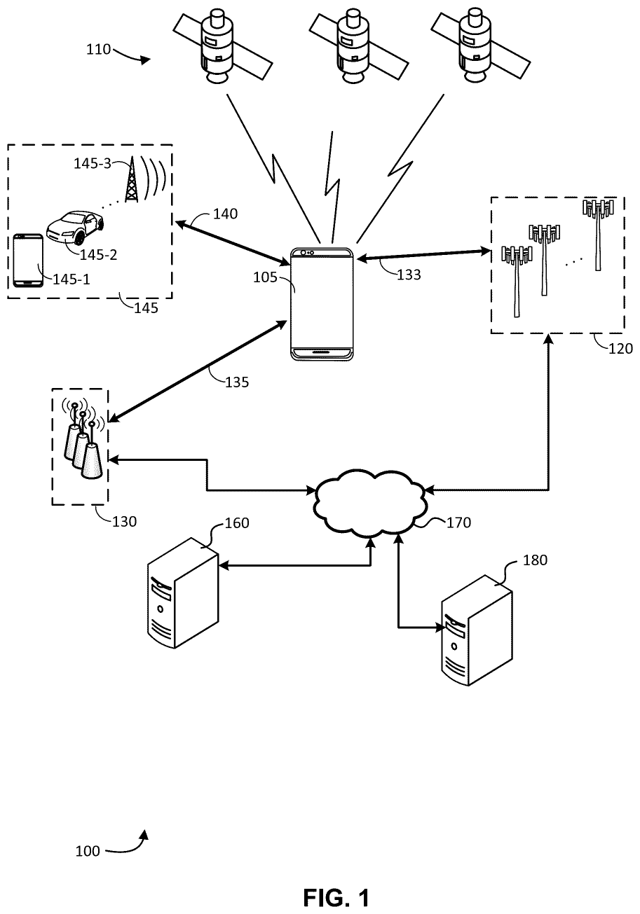

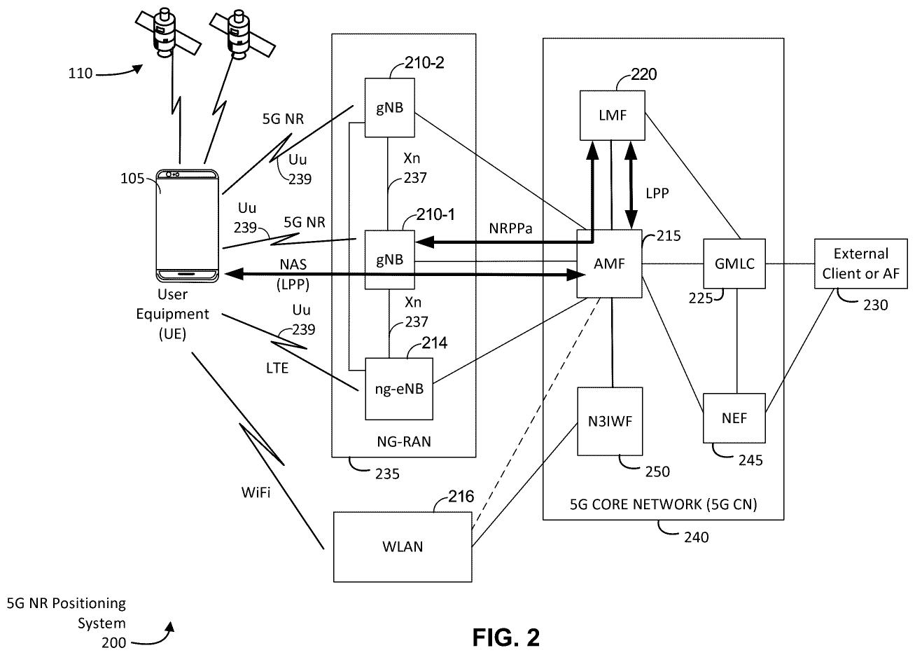

FIG. 1 is a simplified illustration of a positioning system 100 in which a UE 105, location server 160, and/or other components of the positioning system 100 can use the techniques provided herein for sidelink positioning with collinear anchors, according to an embodiment. The techniques described herein may be implemented by one or more components of the positioning system 100. The positioning system 100 can include: a UE 105; one or more satellites 110 (also referred to as space vehicles (SVs)), which may include Global Navigation Satellite System (GNSS) satellites (e.g., satellites of the Global Positioning System (GPS), GLONASS, Galileo, Beidou, etc.) and/or Non-Terrestrial Network (NTN) satellites; base stations 120; access points (APs) 130; location server 160; network 170; and external client 180. Generally put, the positioning system 100 can estimate a location of the UE 105 based on RF signals received by and/or sent from the UE 105 and known locations of other components (e.g., GNSS satellites 110, base stations 120, APs 130) transmitting and/or receiving the RF signals. Additional details regarding particular location estimation techniques are discussed in more detail with regard to FIG. 2.

It should be noted that FIG. 1 provides only a generalized illustration of various components, any or all of which may be utilized as appropriate, and each of which may be duplicated as necessary. Specifically, although only one UE 105 is illustrated, it will be understood that many UEs (e.g., hundreds, thousands, millions, etc.) may utilize the positioning system 100. Similarly, the positioning system 100 may include a larger or smaller number of base stations 120 and/or APs 130 than illustrated in FIG. 1. The illustrated connections that connect the various components in the positioning system 100 comprise data and signaling connections which may include additional (intermediary) components, direct or indirect physical and/or wireless connections, and/or additional networks. Furthermore, components may be rearranged, combined, separated, substituted, and/or omitted, depending on desired functionality. In some embodiments, for example, the external client 180 may be directly connected to location server 160. A person of ordinary skill in the art will recognize many modifications to the components illustrated.

Depending on desired functionality, the network 170 may comprise any of a variety of wireless and/or wireline networks. The network 170 can, for example, comprise any combination of public and/or private networks, local and/or wide-area networks, and the like. Furthermore, the network 170 may utilize one or more wired and/or wireless communication technologies. In some embodiments, the network 170 may comprise a cellular or other mobile network, a wireless local area network (WLAN), a wireless wide-area network (WWAN), and/or the Internet, for example. Examples of network 170 include a Long-Term Evolution (LTE) wireless network, a Fifth Generation (5G) wireless network (also referred to as New Radio (NR) wireless network or 5G NR wireless network), a Wi-Fi WLAN, and the Internet. LTE, 5G and NR are wireless technologies defined, or being defined, by the 3rd Generation Partnership Project (3GPP). Network 170 may also include more than one network and/or more than one type of network.

The base stations 120 and access points (APs) 130 may be communicatively coupled to the network 170. In some embodiments, the base station 120s may be owned, maintained, and/or operated by a cellular network provider, and may employ any of a variety of wireless technologies, as described herein below. Depending on the technology of the network 170, a base station 120 may comprise a node B, an Evolved Node B (eNodeB or eNB), a base transceiver station (BTS), a radio base station (RBS), an NR NodeB (gNB), a Next Generation eNB (ng-eNB), or the like. A base station 120 that is a gNB or ng-eNB may be part of a Next Generation Radio Access Network (NG-RAN) which may connect to a 5G Core Network (5GC) in the case that Network 170 is a 5G network. The functionality performed by a base station 120 in earlier-generation networks (e.g., 3G and 4G) may be separated into different functional components (e.g., radio units (RUs), distributed units (DUs), and central units (CUs)) and layers (e.g., L1/L2/L3) in view Open Radio Access Networks (O-RAN) and/or Virtualized Radio Access Network (V-RAN or vRAN) in 5G or later networks, which may be executed on different devices at different locations connected, for example, via fronthaul, midhaul, and backhaul connections. As referred to herein, a “base station” (or ng-eNB, gNB, etc.) may include any or all of these functional components. An AP 130 may comprise a Wi-Fi AP or a Bluetooth® AP or an AP having cellular capabilities (e.g., 4G LTE and/or 5G NR), for example. Thus, UE 105 can send and receive information with network-connected devices, such as location server 160, by accessing the network 170 via a base station 120 using a first communication link 133. Additionally or alternatively, because APs 130 also may be communicatively coupled with the network 170, UE 105 may communicate with network-connected and Internet-connected devices, including location server 160, using a second communication link 135, or via one or more other mobile devices 145.

As used herein, the term “base station” may generically refer to a single physical transmission point, or multiple co-located physical transmission points, which may be located at a base station 120. A Transmission Reception Point (TRP) (also known as transmit/receive point) corresponds to this type of transmission point, and the term “TRP” may be used interchangeably herein with the terms “gNB,” “ng-eNB,” and “base station.” In some cases, a base station 120 may comprise multiple TRPs—e.g. with each TRP associated with a different antenna or a different antenna array for the base station 120. As used herein, the transmission functionality of a TRP may be performed with a transmission point (TP) and/or the reception functionality of a TRP may be performed by a reception point (RP), which may be physically separate or distinct from a TP. That said, a TRP may comprise both a TP and an RP. Physical transmission points may comprise an array of antennas of a base station 120 (e.g., as in a Multiple Input-Multiple Output (MIMO) system and/or where the base station employs beamforming). The term “base station” may additionally refer to multiple non-co-located physical transmission points, the physical transmission points may be a Distributed Antenna System (DAS) (a network of spatially separated antennas connected to a common source via a transport medium) or a Remote Radio Head (RRH) (a remote base station connected to a serving base station).

As used herein, the term “cell” may generically refer to a logical communication entity used for communication with a base station 120, and may be associated with an identifier for distinguishing neighboring cells (e.g., a Physical Cell Identifier (PCID), a Virtual Cell Identifier (VCID)) operating via the same or a different carrier. In some examples, a carrier may support multiple cells, and different cells may be configured according to different protocol types (e.g., Machine-Type Communication (MTC), Narrowband Internet-of-Things (NB-IoT), Enhanced Mobile Broadband (eMBB), or others) that may provide access for different types of devices. In some cases, the term “cell” may refer to a portion of a geographic coverage area (e.g., a sector) over which the logical entity operates.

Satellites 110 may be utilized for positioning of the UE 105 in one or more ways. For example, satellites 110 (also referred to as space vehicles (SVs)) may be part of a Global Navigation Satellite System (GNSS) such as the Global Positioning System (GPS), GLONASS, Galileo or Beidou. Positioning using RF signals from GNSS satellites may comprise measuring multiple GNSS signals at a GNSS receiver of the UE 105 to perform code-based and/or carrier-based positioning, which can be highly accurate. Additionally or alternatively, satellites 110 may be utilized for NTN-based positioning, in which satellites 110 may functionally operate as TRPs (or TPs) of a network (e.g., LTE and/or NR network) and may be communicatively coupled with network 170. In particular, reference signals (e.g., PRS) transmitted by satellites 110 NTN-based positioning may be similar to those transmitted by base stations 120, and may be coordinated by a location server 160. In some embodiments, satellites 110 used for NTN-based positioning may be different than those used for GNSS-based positioning. In some embodiments NTN nodes may include non-terrestrial vehicles such as airplanes, balloons, drones, etc., which may be in addition or as an alternative to NTN satellites.

The location server 160 may comprise a server and/or other computing device configured to determine an estimated location of UE 105 and/or provide data (e.g., “assistance data”) to UE 105 to facilitate location measurement and/or location determination by UE 105. According to some embodiments, location server 160 may comprise a Home Secure User Plane Location (SUPL) Location Platform (H-SLP), which may support the SUPL user plane (UP) location solution defined by the Open Mobile Alliance (OMA) and may support location services for UE 105 based on subscription information for UE 105 stored in location server 160. In some embodiments, the location server 160 may comprise, a Discovered SLP (D-SLP) or an Emergency SLP (E-SLP). The location server 160 may also comprise an Enhanced Serving Mobile Location Center (E-SMLC) that supports location of UE 105 using a control plane (CP) location solution for LTE radio access by UE 105. The location server 160 may further comprise a Location Management Function (LMF) that supports location of UE 105 using a control plane (CP) location solution for NR or LTE radio access by UE 105.

In a CP location solution, signaling to control and manage the location of UE 105 may be exchanged between elements of network 170 and with UE 105 using existing network interfaces and protocols and as signaling from the perspective of network 170. In a UP location solution, signaling to control and manage the location of UE 105 may be exchanged between location server 160 and UE 105 as data (e.g. data transported using the Internet Protocol (IP) and/or Transmission Control Protocol (TCP)) from the perspective of network 170.

As previously noted (and discussed in more detail below), the estimated location of UE 105 may be based on measurements of RF signals sent from and/or received by the UE 105. In particular, these measurements can provide information regarding the relative distance and/or angle of the UE 105 from one or more components in the positioning system 100 (e.g., GNSS satellites 110, APs 130, base stations 120). The estimated location of the UE 105 can be estimated geometrically (e.g., using multiangulation and/or multilateration), based on the distance and/or angle measurements, along with known position of the one or more components.

Although terrestrial components such as APs 130 and base stations 120 may be fixed, embodiments are not so limited. Mobile components may be used. For example, in some embodiments, a location of the UE 105 may be estimated at least in part based on measurements of RF signals 140 communicated between the UE 105 and one or more other mobile devices 145, which may be mobile or fixed. As illustrated, other mobile devices may include, for example, a mobile phone 145-1, vehicle 145-2, static communication/positioning device 145-3, or other static and/or mobile device capable of providing wireless signals used for positioning the UE 105, or a combination thereof. Wireless signals from mobile devices 145 used for positioning of the UE 105 may comprise RF signals using, for example, Bluetooth® (including Bluetooth Low Energy (BLE)), IEEE 802.11x (e.g., Wi-Fi®), Ultra Wideband (UWB), IEEE 802.15x, or a combination thereof. Mobile devices 145 may additionally or alternatively use non-RF wireless signals for positioning of the UE 105, such as infrared signals or other optical technologies.

Mobile devices 145 may comprise other UEs communicatively coupled with a cellular or other mobile network (e.g., network 170). When one or more other mobile devices 145 comprising UEs are used in the position determination of a particular UE 105, the UE 105 for which the position is to be determined may be referred to as the “target UE,” and each of the other mobile devices 145 used may be referred to as an “anchor UE.” For position determination of a target UE, the respective positions of the one or more anchor UEs may be known and/or jointly determined with the target UE. Direct communication between the one or more other mobile devices 145 and UE 105 may comprise sidelink and/or similar Device-to-Device (D2D) communication technologies. Sidelink, which is defined by 3GPP, is a form of D2D communication under the cellular-based LTE and NR standards. UWB may be one such technology by which the positioning of a target device (e.g., UE 105) may be facilitated using measurements from one or more anchor devices (e.g., mobile devices 145).

According to some embodiments, such as when the UE 105 comprises and/or is incorporated into a vehicle, a form of D2D communication used by the mobile device 105 may comprise vehicle-to-everything (V2X) communication. V2X is a communication standard for vehicles and related entities to exchange information regarding a traffic environment. V2X can include vehicle-to-vehicle (V2V) communication between V2X-capable vehicles, vehicle-to-infrastructure (V2I) communication between the vehicle and infrastructure-based devices (commonly termed roadside units (RSUs)), vehicle-to-person (V2P) communication between vehicles and nearby people (pedestrians, cyclists, and other road users), and the like. Further, V2X can use any of a variety of wireless RF communication technologies. Cellular V2X (CV2X), for example, is a form of V2X that uses cellular-based communication such as LTE (4G), NR (5G) and/or other cellular technologies in a direct-communication mode as defined by 3GPP. The UE 105 illustrated in FIG. 1 may correspond to a component or device on a vehicle, RSU, or other V2X entity that is used to communicate V2X messages. In embodiments in which V2X is used, the static communication/positioning device 145-3 (which may correspond with an RSU) and/or the vehicle 145-2, therefore, may communicate with the UE 105 and may be used to determine the position of the UE 105 using techniques similar to those used by base stations 120 and/or APs 130 (e.g., using multiangulation and/or multilateration). It can be further noted that mobile devices 145 (which may include V2X devices), base stations 120, and/or APs 130 may be used together (e.g., in a WWAN positioning solution) to determine the position of the UE 105, according to some embodiments.

An estimated location of UE 105 can be used in a variety of applications—e.g. to assist direction finding or navigation for a user of UE 105 or to assist another user (e.g. associated with external client 180) to locate UE 105. A “location” is also referred to herein as a “location estimate”, “estimated location”, “location”, “position”, “position estimate”, “position fix”, “estimated position”, “location fix” or “fix”. The process of determining a location may be referred to as “positioning,” “position determination,” “location determination,” or the like. A location of UE 105 may comprise an absolute location of UE 105 (e.g. a latitude and longitude and possibly altitude) or a relative location of UE 105 (e.g. a location expressed as distances north or south, cast or west and possibly above or below some other known fixed location (including, e.g., the location of a base station 120 or AP 130) or some other location such as a location for UE 105 at some known previous time, or a location of a mobile device 145 (e.g., another UE) at some known previous time). A location may be specified as a geodetic location comprising coordinates which may be absolute (e.g. latitude, longitude and optionally altitude), relative (e.g. relative to some known absolute location) or local (e.g. X, Y and optionally Z coordinates according to a coordinate system defined relative to a local area such a factory, warehouse, college campus, shopping mall, sports stadium or convention center). A location may instead be a civic location and may then comprise one or more of a street address (e.g. including names or labels for a country, state, county, city, road and/or street, and/or a road or street number), and/or a label or name for a place, building, portion of a building, floor of a building, and/or room inside a building etc. A location may further include an uncertainty or error indication, such as a horizontal and possibly vertical distance by which the location is expected to be in error or an indication of an area or volume (e.g. a circle or ellipse) within which UE 105 is expected to be located with some level of confidence (e.g. 95% confidence).

The external client 180 may be a web server or remote application that may have some association with UE 105 (e.g. may be accessed by a user of UE 105) or may be a server, application, or computer system providing a location service to some other user or users which may include obtaining and providing the location of UE 105 (e.g. to enable a service such as friend or relative finder, or child or pet location). Additionally or alternatively, the external client 180 may obtain and provide the location of UE 105 to an emergency services provider, government agency, etc.

As previously noted, the example positioning system 100 can be implemented using a wireless communication network, such as an LTE-based or 5G NR-based network. FIG. 2 shows a diagram of a 5G NR positioning system 200, illustrating an embodiment of a positioning system (e.g., positioning system 100) implementing 5G NR. The 5G NR positioning system 200 may be configured to determine the location of a UE 105 by using access nodes, which may include NR NodeB (gNB) 210-1 and 210-2 (collectively and generically referred to herein as gNBs 210), ng-eNB 214, and/or WLAN 216 to implement one or more positioning methods. The gNBs 210 and/or the ng-eNB 214 may correspond with base stations 120 of FIG. 1, and the WLAN 216 may correspond with one or more access points 130 of FIG. 1. Optionally, the 5G NR positioning system 200 additionally may be configured to determine the location of a UE 105 by using an LMF 220 (which may correspond with location server 160) to implement the one or more positioning methods. Here, the 5G NR positioning system 200 comprises a UE 105, and components of a 5G NR network comprising a Next Generation (NG) Radio Access Network (RAN) (NG-RAN) 235 and a 5G Core Network (5G CN) 240. A 5G network may also be referred to as an NR network; NG-RAN 235 may be referred to as a 5G RAN or as an NR RAN; and 5G CN 240 may be referred to as an NG Core network.

The 5G NR positioning system 200 may further utilize information from satellites 110. As previously indicated, satellites 110 may comprise GNSS satellites from a GNSS system like Global Positioning System (GPS) or similar system (e.g. GLONASS, Galileo, Beidou, Indian Regional Navigational Satellite System (IRNSS)). Additionally or alternatively, satellites 110 may comprise NTN satellites that may be communicatively coupled with the LMF 220 and may operatively function as a TRP (or TP) in the NG-RAN 235. As such, satellites 110 may be in communication with one or more gNB 210.

It should be noted that FIG. 2 provides only a generalized illustration of various components, any or all of which may be utilized as appropriate, and each of which may be duplicated or omitted as necessary. Specifically, although only one UE 105 is illustrated, it will be understood that many UEs (e.g., hundreds, thousands, millions, etc.) may utilize the 5G NR positioning system 200. Similarly, the 5G NR positioning system 200 may include a larger (or smaller) number of satellites 110. gNBs 210, ng-eNBs 214, Wireless Local Area Networks (WLANs) 216. Access and mobility Management Functions (AMF)s 215, external clients 230, and/or other components. The illustrated connections that connect the various components in the 5G NR positioning system 200 include data and signaling connections which may include additional (intermediary) components, direct or indirect physical and/or wireless connections, and/or additional networks. Furthermore, components may be rearranged, combined, separated, substituted, and/or omitted, depending on desired functionality.

The UE 105 may comprise and/or be referred to as a device, a mobile device, a wireless device, a mobile terminal, a terminal, a mobile station (MS), a Secure User Plane Location (SUPL)-Enabled Terminal (SET), or by some other name. Moreover, UE 105 may correspond to a cellphone, smartphone, laptop, tablet, personal data assistant (PDA), navigation device, Internet of Things (IoT) device, or some other portable or moveable device. Typically, though not necessarily, the UE 105 may support wireless communication using one or more Radio Access Technologies (RATs) such as using GSM, CDMA, W-CDMA, LTE, High Rate Packet Data (HRPD), IEEE 802.11 Wi-Fi®, Bluetooth, Worldwide Interoperability for Microwave Access (WiMAX™), 5G NR (e.g., using the NG-RAN 235 and 5G CN 240), etc. The UE 105 may also support wireless communication using a WLAN 216 which (like the one or more RATs, and as previously noted with respect to FIG. 1) may connect to other networks, such as the Internet. The use of one or more of these RATs may allow the UE 105 to communicate with an external client 230 (e.g., via elements of 5G CN 240 not shown in FIG. 2, or possibly via a Gateway Mobile Location Center (GMLC) 225) and/or allow the external client 230 to receive location information regarding the UE 105 (e.g., via the GMLC 225). The external client 230 of FIG. 2 may correspond to external client 180 of FIG. 1, as implemented in or communicatively coupled with a 5G NR network.

The UE 105 may include a single entity or may include multiple entities, such as in a personal area network where a user may employ audio, video and/or data I/O devices, and/or body sensors and a separate wireline or wireless modem. An estimate of a location of the UE 105 may be referred to as a location, location estimate, location fix, fix, position, position estimate, or position fix, and may be geodetic, thus providing location coordinates for the UE 105 (e.g., latitude and longitude), which may or may not include an altitude component (e.g., height above sea level, height above or depth below ground level, floor level or basement level). Alternatively, a location of the UE 105 may be expressed as a civic location (e.g., as a postal address or the designation of some point or small area in a building such as a particular room or floor). A location of the UE 105 may also be expressed as an area or volume (defined either geodetically or in civic form) within which the UE 105 is expected to be located with some probability or confidence level (e.g., 67%, 95%, etc.). A location of the UE 105 may further be a relative location comprising, for example, a distance and direction or relative X, Y (and Z) coordinates defined relative to some origin at a known location which may be defined geodetically, in civic terms, or by reference to a point, area, or volume indicated on a map, floor plan or building plan. In the description contained herein, the use of the term location may comprise any of these variants unless indicated otherwise. When computing the location of a UE, it is common to solve for local X, Y, and possibly Z coordinates and then, if needed, convert the local coordinates into absolute ones (e.g. for latitude, longitude and altitude above or below mean sea level).

Base stations in the NG-RAN 235 shown in FIG. 2 may correspond to base stations 120 in FIG. 1 and may include gNBs 210. Pairs of gNBs 210 in NG-RAN 235 may be connected to one another (e.g., directly as shown in FIG. 2 or indirectly via other gNBs 210). The communication interface between base stations (gNBs 210 and/or ng-eNB 214) may be referred to as an Xn interface 237. Access to the 5G network is provided to UE 105 via wireless communication between the UE 105 and one or more of the gNBs 210, which may provide wireless communications access to the 5G CN 240 on behalf of the UE 105 using 5G NR. The wireless interface between base stations (gNBs 210 and/or ng-cNB 214) and the UE 105 may be referred to as a Uu interface 239. 5G NR radio access may also be referred to as NR radio access or as 5G radio access. In FIG. 2, the serving gNB for UE 105 is assumed to be gNB 210-1, although other gNBs (e.g. gNB 210-2) may act as a serving gNB if UE 105 moves to another location or may act as a secondary gNB to provide additional throughput and bandwidth to UE 105.

Base stations in the NG-RAN 235 shown in FIG. 2 may also or instead include a next generation evolved Node B, also referred to as an ng-eNB, 214. Ng-eNB 214 may be connected to one or more gNBs 210 in NG-RAN 235—e.g. directly or indirectly via other gNBs 210 and/or other ng-eNBs. An ng-eNB 214 may provide LTE wireless access and/or evolved LTE (eLTE) wireless access to UE 105. Some gNBs 210 (e.g. gNB 210-2) and/or ng-eNB 214 in FIG. 2 may be configured to function as positioning-only beacons which may transmit signals (e.g., Positioning Reference Signal (PRS)) and/or may broadcast assistance data to assist positioning of UE 105 but may not receive signals from UE 105 or from other UEs. Some gNBs 210 (e.g., gNB 210-2 and/or another gNB not shown) and/or ng-eNB 214 may be configured to function as detecting-only nodes may scan for signals containing, e.g., PRS data, assistance data, or other location data. Such detecting-only nodes may not transmit signals or data to UEs but may transmit signals or data (relating to, e.g., PRS, assistance data, or other location data) to other network entities (e.g., one or more components of 5G CN 240, external client 230, or a controller) which may receive and store or use the data for positioning of at least UE 105. It is noted that while only one ng-eNB 214 is shown in FIG. 2, some embodiments may include multiple ng-eNBs 214. Base stations (e.g., gNBs 210 and/or ng-cNB 214) may communicate directly with one another via an Xn communication interface. Additionally or alternatively, base stations may communicate directly or indirectly with other components of the 5G NR positioning system 200, such as the LMF 220 and AMF 215.

5G NR positioning system 200 may also include one or more WLANs 216 which may connect to a Non-3GPP InterWorking Function (N3IWF) 250 in the 5G CN 240 (e.g., in the case of an untrusted WLAN 216). For example, the WLAN 216 may support IEEE 802.11 Wi-Fi access for UE 105 and may comprise one or more Wi-Fi APs (e.g., APs 130 of FIG. 1). Here, the N3IWF 250 may connect to other elements in the 5G CN 240 such as AMF 215. In some embodiments, WLAN 216 may support another RAT such as Bluetooth. The N3IWF 250 may provide support for secure access by UE 105 to other elements in 5G CN 240 and/or may support interworking of one or more protocols used by WLAN 216 and UE 105 to one or more protocols used by other elements of 5G CN 240 such as AMF 215. For example, N3IWF 250 may support IPSec tunnel establishment with UE 105, termination of IKEv2/IPSec protocols with UE 105, termination of N2 and N3 interfaces to 5G CN 240 for control plane and user plane, respectively, relaying of uplink (UL) and downlink (DL) control plane Non-Access Stratum (NAS) signaling between UE 105 and AMF 215 across an N1 interface. In some other embodiments, WLAN 216 may connect directly to elements in 5G CN 240 (e.g. AMF 215 as shown by the dashed line in FIG. 2) and not via N3IWF 250. For example, direct connection of WLAN 216 to 5GCN 240 may occur if WLAN 216 is a trusted WLAN for 5GCN 240 and may be enabled using a Trusted WLAN Interworking Function (TWIF) (not shown in FIG. 2) which may be an element inside WLAN 216. It is noted that while only one WLAN 216 is shown in FIG. 2, some embodiments may include multiple WLANs 216.

Access nodes may comprise any of a variety of network entities enabling communication between the UE 105 and the AMF 215. As noted, this can include gNBs 210, ng-eNB 214, WLAN 216, and/or other types of cellular base stations. However, access nodes providing the functionality described herein may additionally or alternatively include entities enabling communications to any of a variety of RATs not illustrated in FIG. 2, which may include non-cellular technologies. Thus, the term “access node,” as used in the embodiments described herein below, may include but is not necessarily limited to a gNB 210, ng-eNB 214 or WLAN 216.

In some embodiments, an access node, such as a gNB 210, ng-eNB 214, and/or WLAN 216 (alone or in combination with other components of the 5G NR positioning system 200), may be configured to, in response to receiving a request for location information from the LMF 220, obtain location measurements of uplink (UL) signals received from the UE 105 and/or obtain downlink (DL) location measurements from the UE 105 that were obtained by UE 105 for DL signals received by UE 105 from one or more access nodes. As noted, while FIG. 2 depicts access nodes (gNB 210, ng-eNB 214, and WLAN 216) configured to communicate according to 5G NR, LTE, and Wi-Fi communication protocols, respectively, access nodes configured to communicate according to other communication protocols may be used, such as, for example, a Node B using a Wideband Code Division Multiple Access (WCDMA) protocol for a Universal Mobile Telecommunications Service (UMTS) Terrestrial Radio Access Network (UTRAN), an eNB using an LTE protocol for an Evolved UTRAN (E-UTRAN), or a Bluetooth® beacon using a Bluetooth protocol for a WLAN. For example, in a 4G Evolved Packet System (EPS) providing LTE wireless access to UE 105, a RAN may comprise an E-UTRAN, which may comprise base stations comprising eNBs supporting LTE wireless access. A core network for EPS may comprise an Evolved Packet Core (EPC). An EPS may then comprise an E-UTRAN plus an EPC, where the E-UTRAN corresponds to NG-RAN 235 and the EPC corresponds to 5GCN 240 in FIG. 2. The methods and techniques described herein for obtaining a civic location for UE 105 may be applicable to such other networks.

The gNBs 210 and ng-eNB 214 can communicate with an AMF 215, which, for positioning functionality, communicates with an LMF 220. The AMF 215 may support mobility of the UE 105, including cell change and handover of UE 105 from an access node (e.g., gNB 210, ng-eNB 214, or WLAN 216) of a first RAT to an access node of a second RAT. The AMF 215 may also participate in supporting a signaling connection to the UE 105 and possibly data and voice bearers for the UE 105. The LMF 220 may support positioning of the UE 105 using a CP location solution when UE 105 accesses the NG-RAN 235 or WLAN 216 and may support position procedures and methods, including UE assisted/UE based and/or network based procedures/methods, such as Assisted GNSS (A-GNSS), Observed Time Difference Of Arrival (OTDOA) (which may be referred to in NR as Time Difference Of Arrival (TDOA)), Frequency Difference Of Arrival (FDOA), Real Time Kinematic (RTK), Precise Point Positioning (PPP), Differential GNSS (DGNSS), Enhance Cell ID (ECID), angle of arrival (AoA), angle of departure (AoD), WLAN positioning, round trip signal propagation delay (RTT), multi-cell RTT, and/or other positioning procedures and methods. The LMF 220 may also process location service requests for the UE 105, e.g., received from the AMF 215 or from the GMLC 225. The LMF 220 may be connected to AMF 215 and/or to GMLC 225. In some embodiments, a network such as 5GCN 240 may additionally or alternatively implement other types of location-support modules, such as an Evolved Serving Mobile Location Center (E-SMLC) or a SUPL Location Platform (SLP). It is noted that in some embodiments, at least part of the positioning functionality (including determination of a UE 105's location) may be performed at the UE 105 (e.g., by measuring downlink PRS (DL-PRS) signals transmitted by wireless nodes such as gNBs 210, ng-eNB 214 and/or WLAN 216, and/or using assistance data provided to the UE 105, e.g., by LMF 220).

The Gateway Mobile Location Center (GMLC) 225 may support a location request for the UE 105 received from an external client 230 and may forward such a location request to the AMF 215 for forwarding by the AMF 215 to the LMF 220. A location response from the LMF 220 (e.g., containing a location estimate for the UE 105) may be similarly returned to the GMLC 225 either directly or via the AMF 215, and the GMLC 225 may then return the location response (e.g., containing the location estimate) to the external client 230.

A Network Exposure Function (NEF) 245 may be included in 5GCN 240. The NEF 245 may support secure exposure of capabilities and events concerning 5GCN 240 and UE 105 to the external client 230, which may then be referred to as an Access Function (AF) and may enable secure provision of information from external client 230 to 5GCN 240. NEF 245 may be connected to AMF 215 and/or to GMLC 225 for the purposes of obtaining a location (e.g. a civic location) of UE 105 and providing the location to external client 230.

As further illustrated in FIG. 2, the LMF 220 may communicate with the gNBs 210 and/or with the ng-eNB 214 using an NR Positioning Protocol annex (NRPPa) as defined in 3GPP Technical Specification (TS) 38.455. NRPPa messages may be transferred between a gNB 210 and the LMF 220, and/or between an ng-eNB 214 and the LMF 220, via the AMF 215. As further illustrated in FIG. 2, LMF 220 and UE 105 may communicate using an LTE Positioning Protocol (LPP) as defined in 3GPP TS 37.355. Here, LPP messages may be transferred between the UE 105 and the LMF 220 via the AMF 215 and a serving gNB 210-1 or serving ng-eNB 214 for UE 105. For example, LPP messages may be transferred between the LMF 220 and the AMF 215 using messages for service-based operations (e.g., based on the Hypertext Transfer Protocol (HTTP)) and may be transferred between the AMF 215 and the UE 105 using a 5G NAS protocol. The LPP protocol may be used to support positioning of UE 105 using UE assisted and/or UE based position methods such as A-GNSS, RTK, TDOA, multi-cell RTT. AoD, and/or ECID. The NRPPa protocol may be used to support positioning of UE 105 using network based position methods such as ECID, AoA, uplink TDOA (UL-TDOA) and/or may be used by LMF 220 to obtain location related information from gNBs 210 and/or ng-eNB 214, such as parameters defining DL-PRS transmission from gNBs 210 and/or ng-eNB 214.

In the case of UE 105 access to WLAN 216, LMF 220 may use NRPPa and/or LPP to obtain a location of UE 105 in a similar manner to that just described for UE 105 access to a gNB 210 or ng-eNB 214. Thus, NRPPa messages may be transferred between a WLAN 216 and the LMF 220, via the AMF 215 and N3IWF 250 to support network-based positioning of UE 105 and/or transfer of other location information from WLAN 216 to LMF 220. Alternatively, NRPPa messages may be transferred between N3IWF 250 and the LMF 220, via the AMF 215, to support network-based positioning of UE 105 based on location related information and/or location measurements known to or accessible to N3IWF 250 and transferred from N3IWF 250 to LMF 220 using NRPPa. Similarly, LPP and/or LPP messages may be transferred between the UE 105 and the LMF 220 via the AMF 215, N3IWF 250, and serving WLAN 216 for UE 105 to support UE assisted or UE based positioning of UE 105 by LMF 220.

In a 5G NR positioning system 200, positioning methods can be categorized as being “UE assisted” or “UE based.” This may depend on where the request for determining the position of the UE 105 originated. If, for example, the request originated at the UE (e.g., from an application, or “app,” executed by the UE), the positioning method may be categorized as being UE based. If, on the other hand, the request originates from an external client 230, LMF 220, or other device or service within the 5G network, the positioning method may be categorized as being UE assisted (or “network-based”).

With a UE-assisted position method, UE 105 may obtain location measurements and send the measurements to a location server (e.g., LMF 220) for computation of a location estimate for UE 105. For RAT-dependent position methods location measurements may include one or more of a Received Signal Strength Indicator (RSSI), Round Trip signal propagation Time (RTT), Reference Signal Received Power (RSRP), Reference Signal Received Quality (RSRQ), Reference Signal Time Difference (RSTD), Time of Arrival (TOA), AoA, Receive Time-Transmission Time Difference (Rx-Tx), Differential AoA (DAOA), AoD, or Timing Advance (TA) for gNBs 210, ng-eNB 214, and/or one or more access points for WLAN 216. Additionally or alternatively, similar measurements may be made of sidelink signals transmitted by other UEs, which may serve as anchor points for positioning of the UE 105 if the positions of the other UEs are known. The location measurements may also or instead include measurements for RAT-independent positioning methods such as GNSS (e.g., GNSS pseudorange, GNSS code phase, and/or GNSS carrier phase for satellites 110), WLAN, etc.

With a UE-based position method, UE 105 may obtain location measurements (e.g., which may be the same as or similar to location measurements for a UE assisted position method) and may further compute a location of UE 105 (e.g., with the help of assistance data received from a location server such as LMF 220, an SLP, or broadcast by gNBs 210, ng-eNB 214, or WLAN 216).

With a network based position method, one or more base stations (e.g., gNBs 210 and/or ng-eNB 214), one or more APs (e.g., in WLAN 216), or N3IWF 250 may obtain location measurements (e.g., measurements of RSSI, RTT, RSRP, RSRQ. AoA, or TOA) for signals transmitted by UE 105, and/or may receive measurements obtained by UE 105 or by an AP in WLAN 216 in the case of N3IWF 250, and may send the measurements to a location server (e.g., LMF 220) for computation of a location estimate for UE 105.

Positioning of the UE 105 also may be categorized as UL, DL, or DL-UL based, depending on the types of signals used for positioning. If, for example, positioning is based solely on signals received at the UE 105 (e.g., from a base station or other UE), the positioning may be categorized as DL based. On the other hand, if positioning is based solely on signals transmitted by the UE 105 (which may be received by a base station or other UE, for example), the positioning may be categorized as UL based. Positioning that is DL-UL based includes positioning, such as RTT-based positioning, that is based on signals that are both transmitted and received by the UE 105. Sidelink (SL)-assisted positioning comprises signals communicated between the UE 105 and one or more other UEs. According to some embodiments, UL, DL, or DL-UL positioning as described herein may be capable of using SL signaling as a complement or replacement of SL, DL, or DL-UL signaling.

Depending on the type of positioning (e.g., UL, DL, or DL-UL based) the types of reference signals used can vary. For DL-based positioning, for example, these signals may comprise PRS (e.g., DL-PRS transmitted by base stations or SL-PRS transmitted by other UEs), which can be used for TDOA, AoD, and RTT measurements. Other reference signals that can be used for positioning (UL, DL, or DL-UL) may include Sounding Reference Signal (SRS), Channel State Information Reference Signal (CSI-RS), synchronization signals (e.g., synchronization signal block (SSB) Synchronizations Signal (SS)), Physical Uplink Control Channel (PUCCH), Physical Uplink Shared Channel (PUSCH), Physical Sidelink Shared Channel (PSSCH), Demodulation Reference Signal (DMRS), etc. Moreover, reference signals may be transmitted in a Tx beam and/or received in an Rx beam (e.g., using beamforming techniques), which may impact angular measurements, such as AoD and/or AoA.

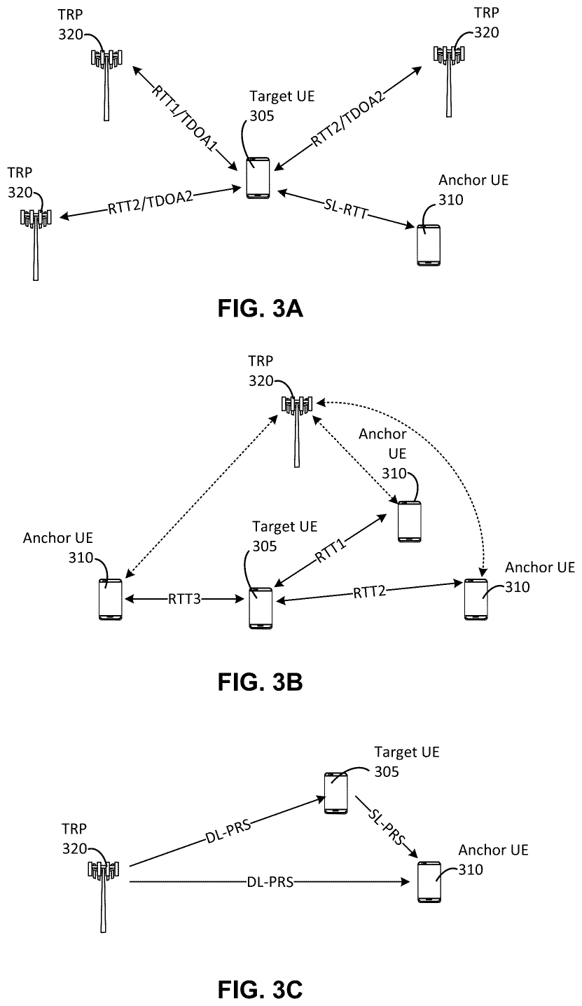

FIGS. 3A-3C are simplified diagrams of scenarios in which sidelink positioning may be used to determine the position of a target UE 305 (e.g., within the systems shown in FIGS. 1 and 2), according to some embodiments. In FIGS. 3A-3C, one or more anchor UEs 310 may be used to send and/or receive reference signals via sidelink. As illustrated, positioning may be further determined using one or more TRPs 320 (base stations) via respective Uu interfaces. It will be understood, however, that the signals used for positioning of the UE 305 may vary, depending on desired functionality. More particularly, some types of positioning may utilize signals other than RTT/TDOA as illustrated in FIGS. 3A-3C.

The diagram of FIG. 3A illustrates a configuration in which the positioning of a target UE 305 may comprise RTT and/or TDOA measurements between the target UE 305 and three TRPs 320. In this configuration, the target UE 305 may be in coverage range for DL and/or UL signals via Uu connections with the TRPs 320. Additionally, the anchor UE 310 at a known location may be used to improve the position determination for the target UE 305 by providing an additional anchor. As illustrated, ranging may be performed between the target UE 305 and anchor UE 310 by taking RTT measurements via the sidelink connection between the target UE 305 and anchor UE 310.

The diagram of FIG. 3B illustrates a configuration in which the positioning of a target UE 305 may use sidelink only (SL-only) positioning/ranging. In this configuration, the target UE 305 may perform RTT measurements via sidelink connections between a plurality of anchor UEs 310. In this example, the target UE 305 may not be in UL coverage of the TRP 320, and therefore each anchor UE 310 may report RTT measurement information to the network of via a Uu connection between each anchor UE 310 and the TRP 320. (In cases in which a UE relays information between a remote UE and a TRP, a UE may be referred to as a “relay” UE.) Such scenarios may exist when the target UE 305 has weaker transmission power than anchor UEs 310 (e.g., the target UE 305 comprises a wearable device, and anchor UEs comprise larger cellular phones, IoT devices, etc.). In other scenarios in which the target UE 305 is within UL coverage of the TRP 320, the target UE 305 may report RTT measurements directly to the TRP 320. In some embodiments, no TRP 320 may be used, in which case one of the UEs (e.g., the target UE 305 or one of the anchor UEs 310) may receive RTT measurement information and determine the position of the target UE 305.

The diagram of FIG. 3C illustrates a configuration in which the positioning of a target UE 305 may comprise the target UE 305 and anchor UE 310 receiving a reference signal (DL-PRS) from the TRP 320, and the target UE 305 sending a reference signal (SL-PRS) to the anchor UE 310. The positioning of the target UE can be determined based on known positions of the TRP 320 and anchor UE 310 and a time difference between a time at which the anchor UE 310 receives the reference signal from the TRP 320 and a time at which the anchor UE 310 receives the reference signal from the target UE 305.

As previously discussed, the use of sidelink positioning (e.g., SL-only or Uu/SL positioning, as illustrated in FIGS. 3A-3C) may utilize RP-P. RP-P may be conveyed to UEs via a sidelink configuration (e.g., using techniques described hereafter), and may designate particular resource pools for sidelink reference signals in different scenarios. Resource pools comprise a set of resources (e.g., frequency and time resources in in an orthogonal frequency-division multiplexing (OFDM) scheme used by 4G and 5G cellular technologies) that may be used for the transmission of RF signals via sidelink for positioning. Each resource pool may further include a particular subcarrier spacing (SCS), cyclic prefix (CP) type, bandwidth (BW) (e.g., subcarriers, bandwidth part, etc.), time-domain location (e.g., periodicity and slot offset).

Resource pools may comprise, for example, Tx resource pools for “Mode 1” sidelink positioning in which sidelink positioning is performed using one or more network-connected UEs, in which case network-based resource allocation may be received by a network-connected UE via a Uu interface with a TRP (e.g., via Downlink Control Information (DCI) or Radio Resource Control (RRC)). Tx resource pools for “Mode 2” sidelink positioning in which autonomous resource selection is performed by UEs without network-based resource allocation. Resource pools may further comprise Rx resource pools, which may be used in either Mode 1 or Mode 2 sidelink positioning. Each RP-P configuration may be relayed via a physical sidelink control channel (PSCCH), which may reserve one or more SL-PRS configurations. Each of the one or more SL-PRS configurations of in RP-P may include respective specific physical layer features such as a number of symbols, comb type, comb-offset, number of subchannels, some channel size, and start resource block (RB). The RP-P configuration may further include a sensing configuration, power control, and/or Channel Busy Ratio (CBR). According to some embodiments, exceptional RP-P can be designated and used in circumstances in which it may not be desirable or possible to perform sidelink positioning via the available resource pools of standard RP-P for sidelink.

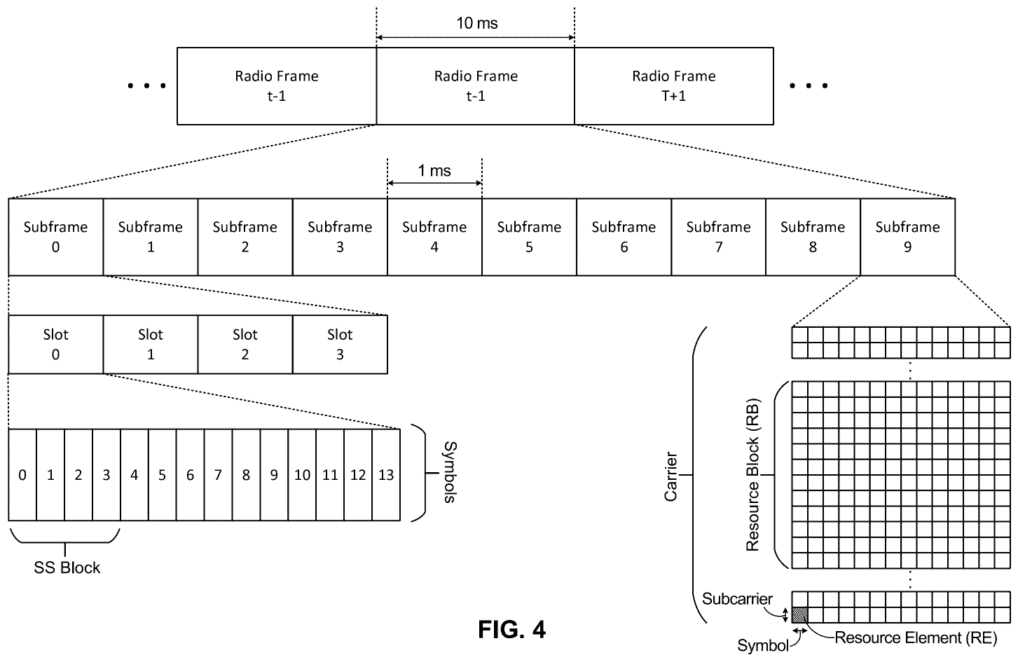

FIG. 4 is a diagram showing an example of a frame structure for NR and associated terminology, which can serve as the basis for physical layer communication between the UE 105 and base stations/TRPs. The transmission timeline for each of the downlink and uplink may be partitioned into units of radio frames. Each radio frame may have a predetermined duration (e.g., 10 ms) and may be partitioned into 10 subframes, each of 1 ms, with indices of 0 through 9. Each subframe may include a variable number of slots depending on the subcarrier spacing. Each slot may include a variable number of symbol periods (e.g., 7 or 14 symbols) depending on the subcarrier spacing. The symbol periods in each slot may be assigned indices. A mini slot may comprise a sub slot structure (e.g., 2, 3, or 4 symbols). Additionally shown in FIG. 4 is the complete Orthogonal Frequency-Division Multiplexing (OFDM) of a subframe, showing how a subframe can be divided across both time and frequency into a plurality of Resource Blocks (RBs). A single RB can comprise a grid of Resource Elements (REs) spanning 14 symbols and 12 subcarriers.

Each symbol in a slot may indicate a link direction (e.g., downlink (DL), uplink (UL), or flexible) or data transmission and the link direction for each subframe may be dynamically switched. The link directions may be based on the slot format. Each slot may include DL/UL data as well as DL/UL control information. In NR, a synchronization signal (SS) block is transmitted. The SS block includes a primary SS (PSS), a secondary SS (SSS), and a two symbol Physical Broadcast Channel (PBCH). The SS block can be transmitted in a fixed slot location, such as the symbols 0-3 as shown in FIG. 4. The PSS and SSS may be used by UEs for cell search and acquisition. The PSS may provide half-frame timing, the SS may provide the cyclic prefix (CP) length and frame timing. The PSS and SSS may provide the cell identity. The PBCH carries some basic system information, such as downlink system bandwidth, timing information within radio frame, SS burst set periodicity, system frame number, etc.

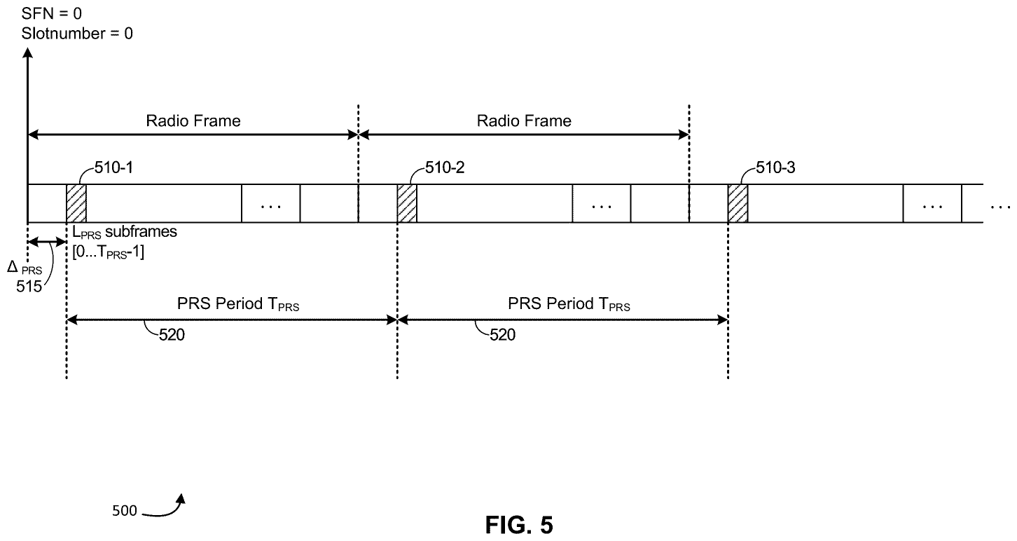

FIG. 5 is a diagram showing an example of a radio frame sequence 500 with PRS positioning occasions. A “PRS instance” or “PRS occasion” is one instance of a periodically repeated time window (e.g., a group of one or more consecutive slots) where PRS are expected to be transmitted. A PRS occasion may also be referred to as a “PRS positioning occasion,” a “PRS positioning instance, a “positioning occasion,” “a positioning instance,” or simply an “occasion” or “instance.” Subframe sequence 500 may be applicable to broadcast of PRS signals (DL-PRS signals) from base stations 120 in positioning system 100. The radio frame sequence 500 may be used in 5G NR (e.g., in 5G NR positioning system 200) and/or in LTE. Similar to FIG. 4, time is represented horizontally (e.g., on an X axis) in FIG. 5, with time increasing from left to right. Frequency is represented vertically (e.g., on a Y axis) with frequency increasing (or decreasing) from bottom to top.

FIG. 5 shows how PRS positioning occasions 510-1, 510-2, and 510-3 (collectively and generically referred to herein as positioning occasions 510) are determined by a System Frame Number (SFN), a cell-specific subframe offset (Δ_{PRS}) 515, a length or span of LPRS subframes, and the PRS Periodicity (T_{PRS}) 520. The cell-specific PRS subframe configuration may be defined by a “PRS Configuration Index,” I_{PRS}, included in assistance data (e.g., TDOA assistance data), which may be defined by governing 3GPP standards. The cell-specific subframe offset (Δ_{PRS}) 515 may be defined in terms of the number of subframes transmitted starting from System Frame Number (SFN) 0 to the start of the first (subsequent) PRS positioning occasion.

A PRS may be transmitted by wireless nodes (e.g., base stations 120) after appropriate configuration (e.g., by an Operations and Maintenance (O&M) server). A PRS may be transmitted in special positioning subframes or slots that are grouped into positioning occasions 510. For example, a PRS positioning occasion 510-1 can comprise a number NPRS of consecutive positioning subframes where the number NPRS may be between 1 and 160 (e.g., may include the values 1, 2, 4 and 6 as well as other values). PRS occasions 510 may be grouped into one or more PRS occasion groups. As noted, PRS positioning occasions 510 may occur periodically at intervals, denoted by a number T_{PRS}, of millisecond (or subframe) intervals where T_{PRS} may equal 5, 10, 20, 40, 80, 160, 320, 640, or 1280 (or any other appropriate value). In some embodiments, T_{PRS} may be measured in terms of the number of subframes between the start of consecutive positioning occasions.

In some embodiments, when a UE 105 receives a PRS configuration index I_{PRS} in the assistance data for a particular cell (e.g., base station), the UE 105 may determine the PRS periodicity T_{PRS} 520 and cell-specific subframe offset (Δ_{PRS}) 515 using stored indexed data. The UE 105 may then determine the radio frame, subframe, and slot when a PRS is scheduled in the cell. The assistance data may be determined by, for example, a location server (e.g., location server 160 in FIG. 1 and/or LMF 220 in FIG. 2), and includes assistance data for a reference cell, and a number of neighbor cells supported by various wireless nodes.

Typically, PRS occasions from all cells in a network that use the same frequency are aligned in time and may have a fixed known time offset (e.g., cell-specific subframe offset (Δ_{PRS}) 515) relative to other cells in the network that use a different frequency. In SFN-synchronous networks all wireless nodes (e.g., base stations 120) may be aligned on both frame boundary and system frame number. Therefore, in SFN-synchronous networks all cells supported by the various wireless nodes may use the same PRS configuration index for any particular frequency of PRS transmission. On the other hand, in SFN-asynchronous networks, the various wireless nodes may be aligned on a frame boundary, but not system frame number. Thus, in SFN-asynchronous networks the PRS configuration index for each cell may be configured separately by the network so that PRS occasions align in time. A UE 105 may determine the timing of the PRS occasions 510 of the reference and neighbor cells for TDOA positioning, if the UE 105 can obtain the cell timing (e.g., SFN or Frame Number) of at least one of the cells, e.g., the reference cell or a serving cell. The timing of the other cells may then be derived by the UE 105 based, for example, on the assumption that PRS occasions from different cells overlap.

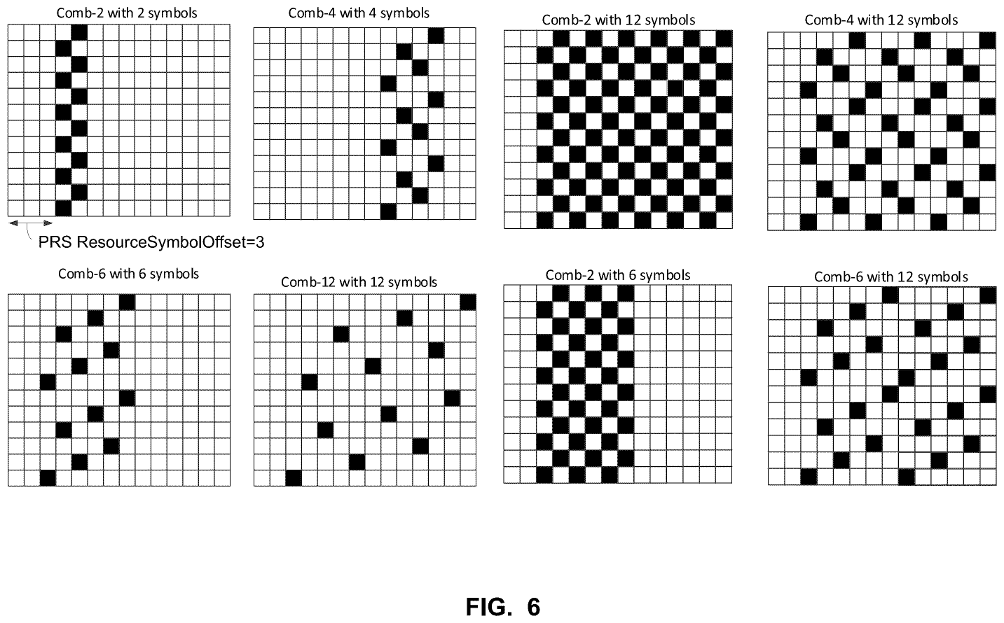

With reference to the frame structure in FIG. 4, a collection of REs that are used for transmission of PRS is referred to as a “PRS resource.” The collection of resource elements can span multiple RBs in the frequency domain and one or more consecutive symbols within a slot in the time domain, inside which pseudo-random Quadrature Phase Shift Keying (QPSK) sequences are transmitted from an antenna port of a TRP. In a given OFDM symbol in the time domain, a PRS resource occupies consecutive RBs in the frequency domain. The transmission of a PRS resource within a given RB has a particular combination, or “comb,” size. (Comb size also may be referred to as the “comb density.”) A comb size “N” represents the subcarrier spacing (or frequency/tone spacing) within each symbol of a PRS resource configuration, where the configuration uses every Nth subcarrier of certain symbols of an RB. For example, for comb-4, for each of the four symbols of the PRS resource configuration, REs corresponding to every fourth subcarrier (e.g., subcarriers 0, 4, 8) are used to transmit PRS of the PRS resource. Comb sizes of comb-2, comb-4, comb-6, and comb-12, for example, may be used in PRS. Examples of different comb sizes using with different numbers of symbols are provided in FIG. 6.

A “PRS resource set” comprises a group of PRS resources used for the transmission of PRS signals, where each PRS resource has a PRS resource ID. In addition, the PRS resources in a PRS resource set are associated with the same TRP. A PRS resource set is identified by a PRS resource set ID and is associated with a particular TRP (identified by a cell ID). A “PRS resource repetition” is a repetition of a PRS resource during a PRS occasion/instance. The number of repetitions of a PRS resource may be defined by a “repetition factor” for the PRS resource. In addition, the PRS resources in a PRS resource set may have the same periodicity, a common muting pattern configuration, and the same repetition factor across slots. The periodicity may have a length selected from 2^{m}·{4, 5, 8, 10, 16, 20, 32, 40, 64, 80, 160, 320, 640, 1280, 2560, 5120, 10240} slots, with μ=0, 1, 2, 3. The repetition factor may have a length selected from {1, 2, 4, 6, 8, 16, 32} slots.

A PRS resource ID in a PRS resource set may be associated with a single beam (and/or beam ID) transmitted from a single TRP (where a TRP may transmit one or more beams). That is, each PRS resource of a PRS resource set may be transmitted on a different beam, and as such, a PRS resource (or simply “resource”) can also be referred to as a “beam.” Note that this does not have any implications on whether the TRPs and the beams on which PRS are transmitted are known to the UE.

In the 5G NR positioning system 200 illustrated in FIG. 2, a TRP (gNB 210, ng-eNB 214, and/or WLAN 216) may transmit frames, or other physical layer signaling sequences, supporting PRS signals (i.e. a DL-PRS) according to frame configurations as previously described, which may be measured and used for position determination of the UE 105. As noted, other types of wireless network nodes, including other UEs, may also be configured to transmit PRS signals configured in a manner similar to (or the same as) that described above. Because transmission of a PRS by a wireless network node may be directed to all UEs within radio range, the wireless network node may be considered to transmit (or broadcast) a PRS.

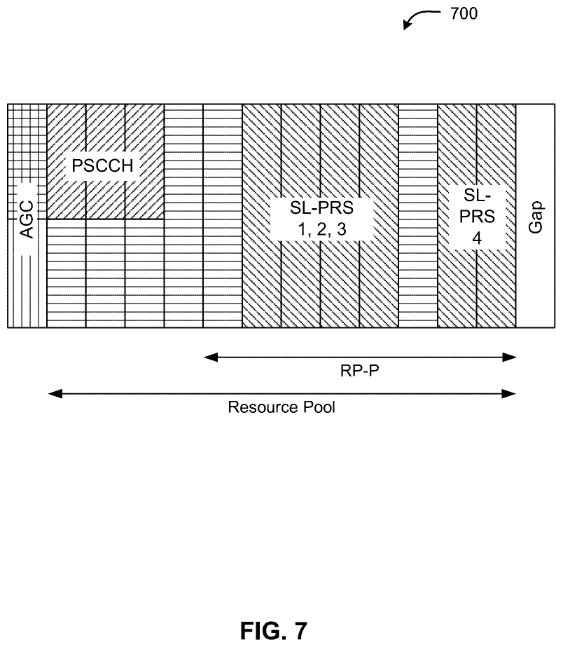

FIG. 7 is a diagram showing an example of a sidelink resource pool 700. In the example of FIG. 7, time is represented horizontally and frequency is represented vertically. In the time domain, the length of each block is an OFDM symbol, and the 14 symbols make up a slot. In the frequency domain, the height of each block is a sub-channel.

In the example of FIG. 7, the entire slot (except for the first and last symbols) can be a resource pool for sidelink transmission and/or reception. That is, any of the symbols other than the first and last can be allocated for transmission and/or reception. However, an RP-P for sidelink transmission/reception is allocated in the last eight pre-gap symbols of the slot. As such, non-sidelink positioning data, such as user data, CSI-RS, and control information, can only be transmitted in the first four post-AGC symbols and not in the last eight pre-gap symbols to prevent a collision with the configured RP-P. Non-sidelink positioning data that would otherwise be transmitted in the last eight pre-gap symbols can be punctured or muted, and/or non-sidelink data that would normally span more than the four post-AGC symbols can be rate matched to fit into the four post-AGC symbols.

Sidelink positioning reference signals (SL-PRS) have been defined to enable sidelink positioning procedures among UEs. Like PRS and SRS, SL-PRS resources are composed of one or more resource elements (i.e., one OFDM symbol in the time domain and one subcarrier in the frequency domain). SL-PRS resources can be designed with a comb-based pattern to enable fast Fourier transform (FFT)-based processing at the receiver. SL-PRS resources can be composed of unstaggered, or only partially staggered, resource elements in the frequency domain to provide small time of arrival (TOA) uncertainty and reduced overhead of each SL-PRS resource. In the example of FIG. 7, as shown, four SL-PRS resources (labeled SL-PRS 1, 2, 3, 4) are transmitted (or scheduled for transmission) in the RP-P. Note that although FIG. 7 illustrates the SL-PRS as contiguous in the frequency domain, they may instead follow a comb pattern within the sub-channel.

SL-PRS may be associated with specific RP-Ps (e.g., certain SL-PRS may be allocated in certain RP-Ps). SL-PRS can be configured to feature intra-slot repetition (not shown in FIG. 7) to allow for combining gains (if needed). Inter-UE coordination of RP-Ps may be performed to provide for dynamic SL-PRS and data multiplexing while minimizing SL-PRS collisions.

As discussed herein, in some embodiments, TDOA assistance data may be provided to a UE 105 by a location server (e.g., location server 160) for a “reference cell” (which also may be called “reference resource”), and one or more “neighbor cells” or “neighboring cells” (which also may be called a “target cell” or “target resource”), relative to the reference cell. For example, the assistance data may provide the center channel frequency of each cell, various PRS configuration parameters (e.g., NPRS, T_{PRS}, muting sequence, frequency hopping sequence, PRS ID, PRS bandwidth), a cell global ID, PRS signal characteristics associated with a directional PRS, and/or other cell related parameters applicable to TDOA or some other position method. PRS-based positioning by a UE 105 may be facilitated by indicating the serving cell for the UE 105 in the TDOA assistance data (e.g., with the reference cell indicated as being the serving cell).

In some embodiments, TDOA assistance data may also include “expected Reference Signal Time Difference (RSTD)” parameters, which provide the UE 105 with information about the RSTD values the UE 105 is expected to measure at its current location between the reference cell and each neighbor cell, together with an uncertainty of the expected RSTD parameter. The expected RSTD, together with the associated uncertainty, may define a search window for the UE 105 within which the UE 105 is expected to measure the RSTD value. TDOA assistance information may also include PRS configuration information parameters, which allow a UE 105 to determine when a PRS positioning occasion occurs on signals received from various neighbor cells relative to PRS positioning occasions for the reference cell, and to determine the PRS sequence transmitted from various cells in order to measure a signal ToA or RSTD.

Using the RSTD measurements, the known absolute or relative transmission timing of each cell, and the known position(s) of wireless node physical transmitting antennas for the reference and neighboring cells, the UE position may be calculated (e.g., by the UE 105 or by the location server 160). More particularly, the RSTD for a neighbor cell “k” relative to a reference cell “Ref,” may be given as (ToAk-ToARes), where the ToA values may be measured modulo one subframe duration (1 ms) to remove the effects of measuring different subframes at different times. ToA measurements for different cells may then be converted to RSTD measurements and sent to the location server 160 by the UE 105. Using (i) the RSTD measurements, (ii) the known absolute or relative transmission timing of each cell, (iii) the known position(s) of physical transmitting antennas for the reference and neighboring cells, and/or (iv) directional PRS characteristics such as a direction of transmission, the UE 105 position may be determined.

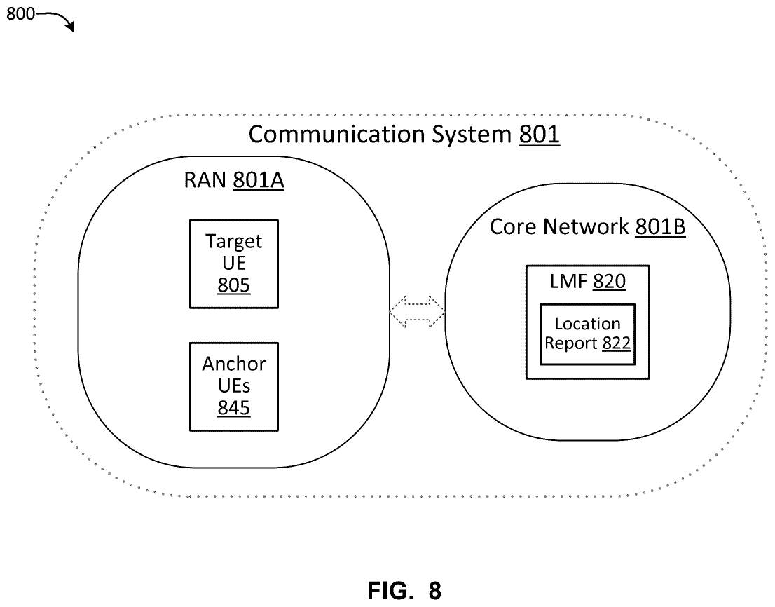

FIG. 8 is a block diagram of an example operating environment 800 that may be representative of various implementations. In operating environment 800, sidelink positioning can be conducted for a target UE 805 operating in a RAN 801A of a communication system 801. According to some implementations, target UE 805 can correspond to UE 105 of FIGS. 1 and 2. According to various implementations, RAN 801A can be a 3GPP 5G RAN, such as an NG-RAN. According to various implementations, RAN 801A can correspond to NG-RAN 235 of FIG. 2. For the purpose of sidelink positioning of target UE 805, other UEs operating in RAN 801A can act as anchor UEs 845. In conjunction with this role, anchor UEs 845 can transmit positioning signals (such as SL-PRSs) to be measured by target UE 805, measure positioning signals (such as SL-PRSs) transmitted by target UE 805, or both. Similarly, target UE 805 can transmit positioning signals (such as SL-PRSs) to be measured by anchor UEs 845, measure positioning signals (such as SL-PRSs) transmitted by anchor UEs 845, or both.

In a core network 801B of communication system 801, an LMF 820 can estimate a location of target UE 805 based on positioning measurements associated with target UE 805. In various implementations, core network 801B can be a 3GPP 5G core network (5GC). In various implementations, core network 801B can correspond to 5G CN 240 of FIG. 2. According to aspects of the disclosure, the positioning measurements associated with target UE 805 can include measurements by target UE 805 of positioning signals transmitted by anchor UEs 845, measurements by anchor UEs 845 of positioning signals transmitted by target UE 805, or both.

In operating environment 800, LMF 820 can provide a location report 822 to a location requesting entity (e.g., a location consumer) associated with target UE 805. The location requesting entity or location consumer can be an entity that requests location information for target UE 805. According to aspects of the disclosure, the location consumer can reside at the target UE 805, or at an anchor UE 845, or another entity that requests the location information for the target UE 805 through the LMF. The location report 822 can indicate the estimated location of target UE 805, such as in the form of geographic coordinates, for example.

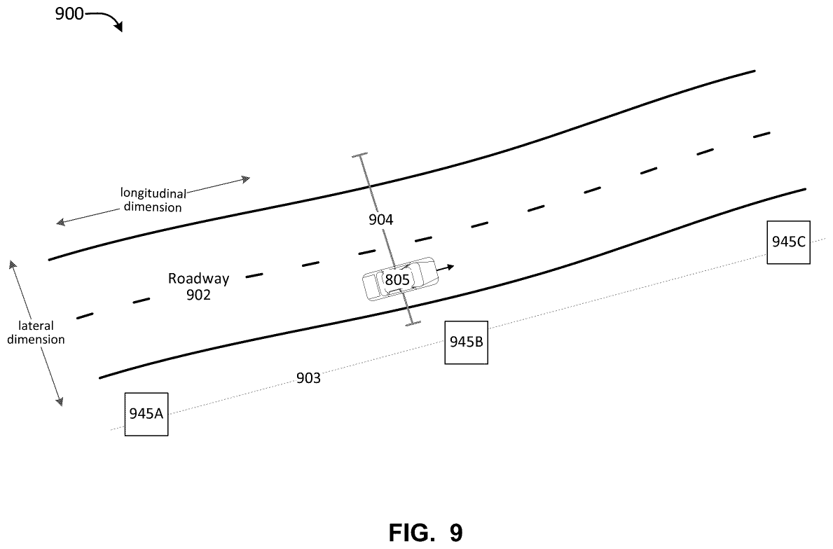

FIG. 9 is a block diagram of an example operating environment 900 that may be representative of various implementations. In operating environment 900, the target UE 805 of FIG. 8 travels along a roadway 902. As reflected in FIG. 9, in this example, target UE 805 may be—or may be comprised in-a vehicle. Wireless communication devices (such as RSUs) that are capable of operating as anchor UEs can be installed along roadway 902 to support sidelink positioning for vehicles that travel roadway 902. For the purpose of sidelink positioning of target UE 805 in the example of operating environment 900, wireless communication devices installed along roadway 902 can serve as anchor UEs 945A, 945B, and 945C.

Anchor UEs 945A, 945B, and 945C are substantially collinear anchors, as they each lie approximately on a same line 903. With respect to a longitudinal dimension substantially parallel to line 903, the collinearity of anchor UEs 945A, 945B, and 945C may not significantly impact the accuracy of sidelink positioning of target UE 805. However, the collinearity of anchor UEs 945A, 945B, and 945C may hamper the accuracy of sidelink positioning of target UE 805 with respect to a lateral dimension substantially perpendicular to the longitudinal dimension. In the depicted example, due to impaired accuracy attributable to the collinearity of anchor UEs 945A, 945B, and 945C, the position of target UE 805 in the lateral dimension can only be determined to be some point along a line segment 904 that extends beyond both sides of roadway 902.

Disclosed herein are techniques for sidelink positioning using collinear anchors that may be implemented to mitigate impairment upon the accuracy of sidelink positioning involving collinear anchor UEs, such as those in operating environment 900 of FIG. 9. According to techniques disclosed herein, when a set of anchor UEs is selected for sidelink positioning of a target UE, a determination can be made of whether the set of anchor UEs is collinear. In some implementations, a collinearity metric value associated with the set of anchor UEs can be determined based on the respective locations of the anchor UEs, and can be compared to a threshold to determine whether the set of anchor UEs is collinear. In various implementations, if the set of anchor UEs is collinear, estimation and/or reporting of the target UE's location can be adapted to mitigate impairment that the collinearity of the anchor UEs may tend to impose upon the accuracy of sidelink positioning. In some implementations, the accuracy of sidelink positioning involving collinear anchor UEs can be improved using supplemental positioning measurements, other supplemental information, or both. In some implementations, location estimates obtained via sidelink positioning involving collinear anchor UEs can be conveyed in such a way as to notify location requesting entities (location consumers) of the collinearity of the anchor UEs involved. In various implementations, location estimates obtained via sidelink positioning involving collinear anchor UEs can be conveyed in location reports that include indications of uncertainties attributable to the collinearity of the anchor UEs.

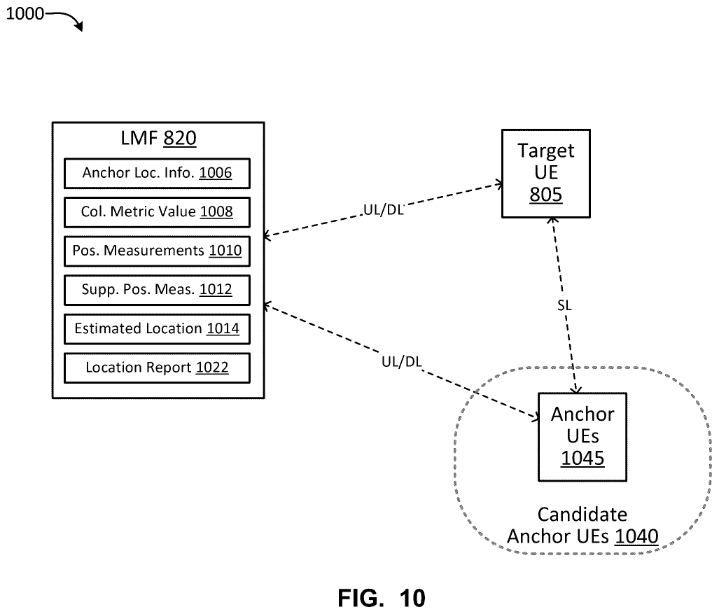

FIG. 10 is a block diagram of an example operating environment 1000 that may be representative of the implementation of techniques disclosed herein for sidelink positioning using collinear anchors. In operating environment 1000, sidelink positioning of target UE 805 is conducted using anchor UEs 1045. In various implementations, anchor UEs 1045 can be RSUs. In some implementations, LMF 820 can identify a plurality of candidate anchor UEs 1040 generally consisting of UEs in the vicinity of target UE 805 that are capable of serving as anchor UEs for sidelink positioning of target UE 805, and can select anchor UEs 1045 from among the plurality of candidate anchor UEs 1040.

According to aspects of the disclosure, LMF 820 can determine a collinearity metric value 1008 that represents a value of a collinearity metric for the set of anchor UEs 1045. The collinearity metric value 1008 can generally indicate an extent to which the respective positions of anchor UEs 1045 deviate (or do not deviate) from full collinearity. In some implementations, LMF 820 can determine collinearity metric value 1008 based on anchor location information 1006 indicating respective locations of the various anchor UEs 1045. In some implementations, LMF 820 can receive anchor location information 1006 from target UE 805.

In various implementations, LMF 820 can determine whether anchor UEs 1045 are collinear by comparing collinearity metric value 1008 with a threshold value. In some implementations, larger values of the collinearity metric can correspond to greater degrees of collinearity, and LMF 820 can determine whether anchor UEs 1045 are collinear based on whether collinearity metric value 1008 exceeds a threshold value. In other implementations, smaller values of the collinearity metric can correspond to greater degrees of collinearity, and LMF 820 can determine whether anchor UEs 1045 are collinear based on whether collinearity metric value 1008 is less than a threshold value.

In some implementations, LMF 820 can select anchor UEs 1045 from among the plurality of candidate anchor UEs 1040 with reference to the collinearity metric. For instance, in some implementations, LMF 820 can select, from among the plurality of candidate anchor UEs 1040, a set of anchor UEs 1045 that yields collinearity metric value 1008 corresponding to a lowest (or lower) degree of collinearity. In some implementations, LMF 820 can select, based on anchor location information 1006, a least (or less) collinear set of anchor UEs 1045 from among the plurality of candidate anchor UEs 1040, determine the collinearity metric value 1008 for the selected set of anchor UEs 1045, and determine whether the selected set of anchor UEs 1045 is collinear by comparing the collinearity metric value 1008 with a threshold.

According to aspects of the disclosure, responsive to a determination that the set of anchor UEs 845 is collinear, LMF 820 can initiate a collinear anchor positioning procedure. In various implementations, in conjunction with the collinear anchor positioning procedure, LMF 820 can determine an estimated location 1014 of target UE 805 based on positioning measurements 1010 associated with anchor UEs 1045. In some implementations, positioning measurements 1010 can include measurements obtained by anchor UEs 1045 by measuring reference signals transmitted by target UE 805. In some implementations, positioning measurements 1010 can additionally or alternatively include measurements obtained by target UE 805 (and then provided to LMF 820) by measuring reference signals transmitted by anchor UEs 1045. In various implementations, positioning measurements 1010 can include round-trip time (RTT) measurements. In some implementations, positioning measurements 1010 can additionally or alternatively include time difference of arrival (TDoA) measurements.

In various implementations, according to the collinear anchor positioning procedure, LMF 820 can generate a location report 1022 that includes the estimated location 1014 of target UE 805, and can provide the location report 1022 to a location requesting entity (location consumer) associated with target UE 805. According to aspects of the disclosure, the location report 1022 can include an indication that the estimated location 1014 of target UE 805 is based on collinear anchor positioning measurements—that is, positioning measurements obtained by—and/or obtained based on reference signals transmitted by—collinear anchor UEs. In some implementations, the indication that the estimated location 1014 of target UE 805 is based on collinear anchor positioning measurements can be an explicit indication, such as an indication provided by setting a bit, flag, or field in location report 1022 to a particular value. In other implementations, the indication that the estimated location 1014 of target UE 805 is based on collinear anchor positioning measurements can be an implicit indication. In some implementations, for example, location report 1022 can indicate a lateral uncertainty associated with the estimated location of target UE 805, and the indication of the lateral uncertainty can serve as an implicit indication that estimated location 1014 of target UE 805 is based on collinear anchor positioning measurements. In another example, in some implementations, location report 1022 can indicate a relative orientation of a lateral dimension associated with the estimated location of the target UE, and the indication of the relative orientation of the lateral dimension can serve as an implicit indication that estimated location 1014 of target UE 805 is based on collinear anchor positioning measurements.

In some implementations, according to the collinear anchor positioning procedure, LMF 820 can request supplemental positioning measurements 1012 associated with one or more of the set of anchor UEs 1045 and can determine the estimated location 1014 of target UE 805 based on positioning measurements 1010 and the supplemental positioning measurements 1012. In some implementations, supplemental positioning measurements 1012 can include measurements by one or more of the set of anchor UEs 1045 of reference signals transmitted by target UE 805. In various implementations, supplemental positioning measurements 1012 can additionally or alternatively include measurements by target UE 805 of reference signals transmitted by one or more of the set of anchor UEs 1045.

It is worthy of note that according to aspects of the disclosure, rather than being orchestrated by LMF 820, sidelink positioning of target UE 805 in operating environment 1000 may be orchestrated by target UE 805 in some implementations. In various such implementations, operations described above as being performed by LMF 820 may instead be performed by target UE 805. Examples of operations that target UE 805 may perform in conjunction with orchestrating sidelink positioning of itself may include, without limitation, selecting the set of anchor UEs 1045, determining whether the set of anchor UEs 1045 is collinear, determining the estimated location 1014 of target UE 805, generating the location report 1022, and providing the location report 1022 to location requesting entities (location consumers) associated with target UE 805.

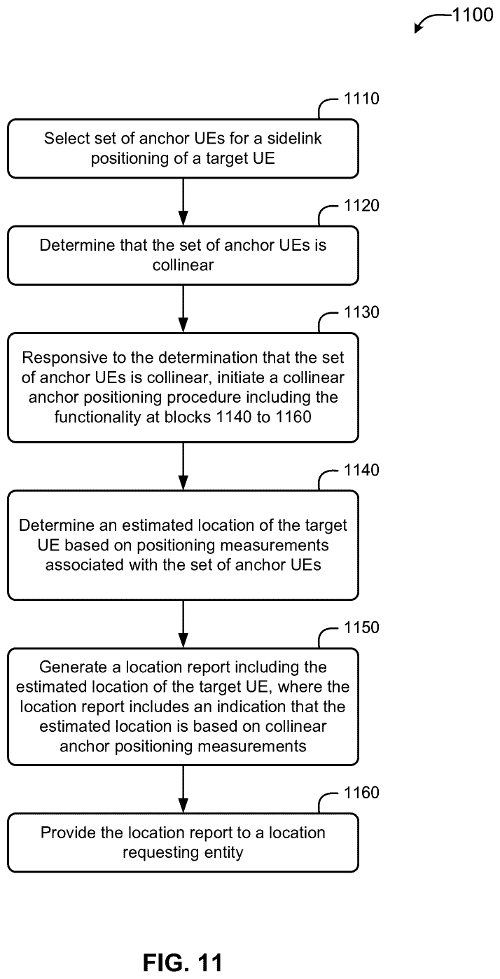

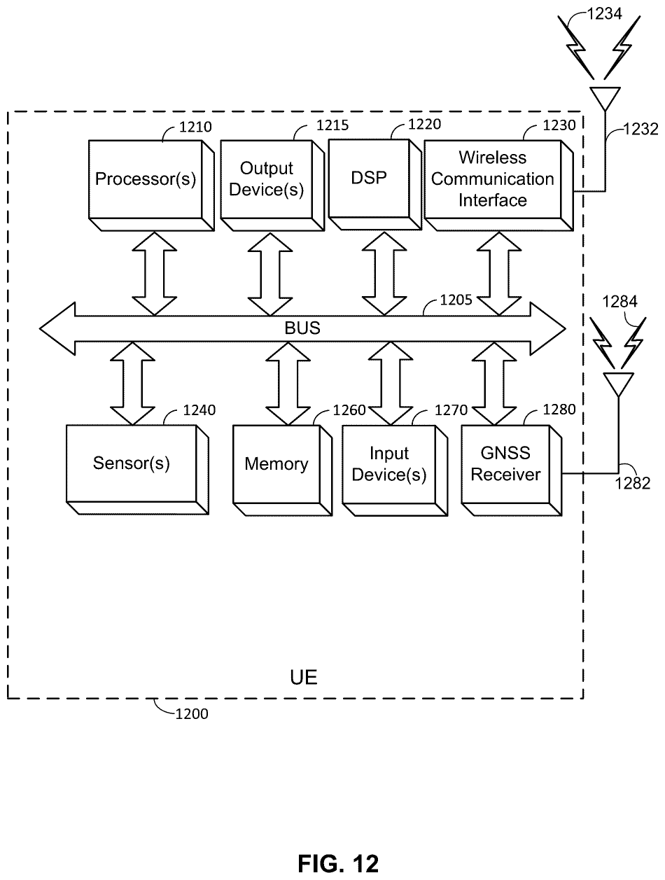

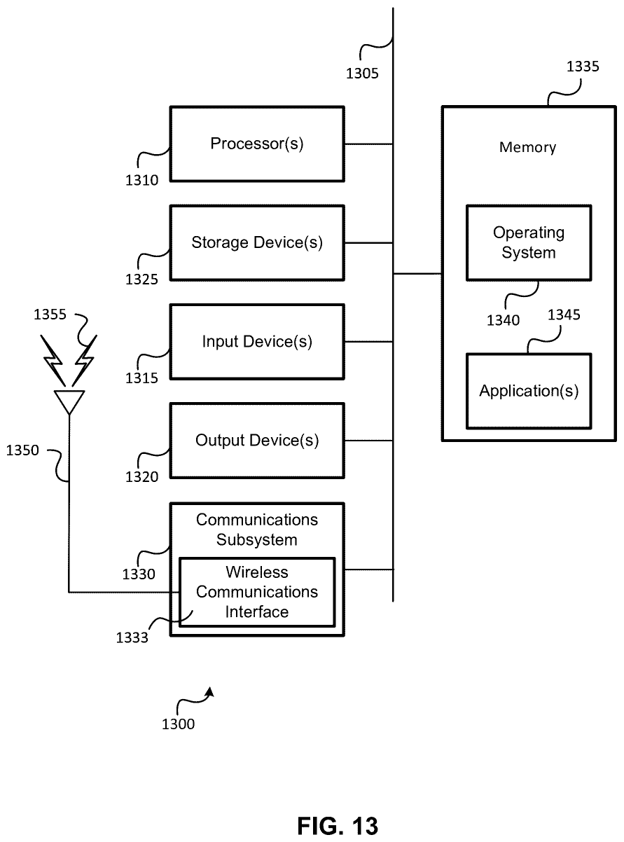

FIG. 11 is a logic flow 1100 illustrating an example sidelink positioning method, according to aspects of the disclosure. In some implementations, means for performing the functionality illustrated in one or more of the blocks shown in FIG. 11 may be provided by hardware and/or software components of a computer system that implements an LMF. Example components of a computer system are illustrated in FIG. 13, which is described in more detail below. In some implementations, means for performing the functionality illustrated in one or more of the blocks shown in FIG. 11 may be provided by hardware and/or software components of a mobile device, such as a UE. Example components of a UE are illustrated in FIG. 12, which is described in more detail below. In some examples, LMF 820 may perform the functionality illustrated in one or more of the blocks shown in FIG. 11 in operating environment 1000 of FIG. 10. In some examples, target UE 805 may perform the functionality illustrated in one or more of the blocks shown in FIG. 11 in operating environment 1000 of FIG. 10.

At block 1110, the functionality comprises selecting a set of anchor UEs for a sidelink positioning of a target UE. For example, in operating environment 1000 of FIG. 10, LMF 820 or target UE 805 may select the set of anchor UEs 1045. Means for performing functionality at block 1110 may comprise a bus 1305, processors 1310, communications subsystem 1330, memory 1335, and/or other components of a computer system, as illustrated in FIG. 13, or may comprise a bus 1205, processors 1210, digital signal processor (DSP) 1220, wireless communication interface 1230, memory 1260, and/or other components of a UE, as illustrated in FIG. 12. In some implementations, the anchor UEs of the set of anchor UEs can be RSUs. In various implementations, a plurality of candidate anchor UEs can be identified for the sidelink positioning of the target UE, and the set of anchor UEs can be selected from among the plurality of candidate anchor UEs.

At block 1120, the functionality comprises determining that the set of anchor UEs selected at block 1110 is collinear. For example, in operating environment 1000 of FIG. 10, LMF 820 or target UE 805 may determine that anchor UEs 1045 are collinear. Means for performing functionality at block 1120 may comprise a bus 1305, processors 1310, communications subsystem 1330, memory 1335, and/or other components of a computer system, as illustrated in FIG. 13, or may comprise a bus 1205, processors 1210, digital signal processor (DSP) 1220, wireless communication interface 1230, memory 1260, and/or other components of a UE, as illustrated in FIG. 12. In some implementations, a value of a collinearity metric can be determined for the set of anchor UEs, and the determination that the set of anchor UEs is collinear can be made at 1120 based on the value of the collinearity metric. In some such implementations, the determination that the set of anchor UEs is collinear can be based on a comparison of the collinearity metric with a threshold. In various implementations, the value of the collinearity metric can be determined based on anchor location information indicating respective locations of the set of anchor UEs. In some implementations, the anchor location information can be received from the target UE. At block 1130, the functionality comprises initiating, responsive to the determination at block 1120 that the set of anchor UEs is collinear, a collinear anchor positioning procedure including the functionality at blocks 1140 to 1160.

At block 1140, the functionality comprises determining an estimated location of the target UE based on positioning measurements associated with the set of anchor UEs. For example, in operating environment 1000 of FIG. 10, LMF 820 or target UE 805 may determine the estimated location 1014 of target UE 805 based on positioning measurements 1010. Means for performing functionality at block 1140 may comprise a bus 1305, processors 1310, communications subsystem 1330, memory 1335, and/or other components of a computer system, as illustrated in FIG. 13, or may comprise a bus 1205, processors 1210, digital signal processor (DSP) 1220, wireless communication interface 1230, memory 1260, and/or other components of a UE, as illustrated in FIG. 12. In some implementations, the positioning measurements associated with the set of anchor UEs can comprise round-trip time (RTT) measurements. In some implementations, the positioning measurements associated with the set of anchor UEs can comprise time difference of arrival (TDoA) measurements. In various implementations, the collinear anchor positioning procedure can further comprise requesting supplemental positioning measurements associated with one or more of the set of anchor UEs, and determining the estimated location of the target UE based on the positioning measurements associated with the set of anchor UEs and the supplemental positioning measurements associated with the one or more of the set of anchor UEs.

At block 1150, the functionality comprises generating a location report including the estimated location of the target UE, where the location report includes an indication that the estimated location is based on collinear anchor positioning measurements. For example, in operating environment 1000 of FIG. 10, LMF 820 or target UE 805 may generate a location report 1022 including the estimated location 1014 of target UE 805, and location report 1022 may include an indication that estimated location 1014 is based on collinear anchor positioning measurements. Means for performing functionality at block 1150 may comprise a bus 1305, processors 1310, communications subsystem 1330, memory 1335, and/or other components of a computer system, as illustrated in FIG. 13, or may comprise a bus 1205, processors 1210, digital signal processor (DSP) 1220, wireless communication interface 1230, memory 1260, and/or other components of a UE, as illustrated in FIG. 12.

In various implementations, the location report can indicate a lateral uncertainty associated with the estimated location of the target UE. In some implementations, the location report can indicate a relative orientation of a lateral dimension associated with the estimated location of the target UE.

At block 1160, the functionality comprises providing the location report to a location requesting entity (location consumer). For example, in operating environment 1000 of FIG. 10, LMF 820 or target UE 805 may provide location report 1022 to a location requesting entity (location consumer) associated with target UE 805. Means for performing functionality at block 1160 may comprise a bus 1305, processors 1310, communications subsystem 1330, memory 1335, and/or other components of a computer system, as illustrated in FIG. 13, or may comprise a bus 1205, processors 1210, digital signal processor (DSP) 1220, wireless communication interface 1230, memory 1260, and/or other components of a UE, as illustrated in FIG. 12.

FIG. 12 is a block diagram of an embodiment of a UE 1200, which can be utilized as described herein above (e.g., in association with FIGS. 1-3 and 8-11). For example, the UE 1200 can be used to implement one or more of UE 105 of FIGS. 1 and 2, target UE 305 of FIG. 3, and target UE 805 of FIGS. 8-10. In some examples, UE 1200 can perform one or more operations associated with the sidelink positioning method of FIG. 11. It should be noted that FIG. 12 is meant only to provide a generalized illustration of various components, any or all of which may be utilized as appropriate. It can be noted that, in some instances, components illustrated by FIG. 12 can be localized to a single physical device and/or distributed among various networked devices, which may be disposed at different physical locations. Furthermore, as previously noted, the functionality of the UE discussed in the previously described embodiments may be executed by one or more of the hardware and/or software components illustrated in FIG. 12.

The UE 1200 is shown comprising hardware elements that can be electrically coupled via a bus 1205 (or may otherwise be in communication, as appropriate). The hardware elements may include a processor(s) 1210 which can include without limitation one or more general-purpose processors (e.g., an application processor), one or more special-purpose processors (such as digital signal processor (DSP) chips, graphics acceleration processors, application specific integrated circuits (ASICs), and/or the like), and/or other processing structures or means. Processor(s) 1210 may comprise one or more processing units, which may be housed in a single integrated circuit (IC) or multiple ICs. As shown in FIG. 12, some embodiments may have a separate DSP 1220, depending on desired functionality. Location determination and/or other determinations based on wireless communication may be provided in the processor(s) 1210 and/or wireless communication interface 1230 (discussed below). The UE 1200 also can include one or more input devices 1270, which can include without limitation one or more keyboards, touch screens, touch pads, microphones, buttons, dials, switches, and/or the like; and one or more output devices 1215, which can include without limitation one or more displays (e.g., touch screens), light emitting diodes (LEDs), speakers, and/or the like.

The UE 1200 may also include a wireless communication interface 1230, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, a WAN device, and/or various cellular devices, etc.), and/or the like, which may enable the UE 1200 to communicate with other devices as described in the embodiments above. The wireless communication interface 1230 may permit data and signaling to be communicated (e.g., transmitted and received) with TRPs of a network, for example, via eNBs, gNBs, ng-eNBs, access points, various base stations and/or other access node types, and/or other network components, computer systems, and/or any other electronic devices communicatively coupled with TRPs, as described herein. The communication can be carried out via one or more wireless communication antenna(s) 1232 that send and/or receive wireless signals 1234. According to some embodiments, the wireless communication antenna(s) 1232 may comprise a plurality of discrete antennas, antenna arrays, or any combination thereof. The antenna(s) 1232 may be capable of transmitting and receiving wireless signals using beams (e.g., Tx beams and Rx beams). Beam formation may be performed using digital and/or analog beam formation techniques, with respective digital and/or analog circuitry. The wireless communication interface 1230 may include such circuitry.

Depending on desired functionality, the wireless communication interface 1230 may comprise a separate receiver and transmitter, or any combination of transceivers, transmitters, and/or receivers to communicate with base stations (e.g., ng-eNBs and gNBs) and other terrestrial transceivers, such as wireless devices and access points. The UE 1200 may communicate with different data networks that may comprise various network types. For example, a WWAN may be a CDMA network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMAX (IEEE 802.16) network, and so on. A CDMA network may implement one or more RATs such as CDMA2000®, WCDMA, and so on. CDMA2000® includes IS-95, IS-2000 and/or IS-856 standards. A TDMA network may implement GSM, Digital Advanced Mobile Phone System (D-AMPS), or some other RAT. An OFDMA network may employ LTE, LTE Advanced, 5G NR, and so on. 5G NR, LTE, LTE Advanced, GSM, and WCDMA are described in documents from 3GPP. CDMA2000® is described in documents from a consortium named “3rd Generation Partnership Project 2” (3GPP2). 3GPP and 3GPP2 documents are publicly available. A wireless local area network (WLAN) may also be an IEEE 802.11x network, and a wireless personal area network (WPAN) may be a Bluetooth network, an IEEE 802.15x, or some other type of network. The techniques described herein may also be used for any combination of WWAN, WLAN and/or WPAN.

The UE 1200 can further include sensor(s) 1240. Sensor(s) 1240 may comprise, without limitation, one or more inertial sensors and/or other sensors (e.g., accelerometer(s), gyroscope(s), camera(s), magnetometer(s), altimeter(s), microphone(s), proximity sensor(s), light sensor(s), barometer(s), and the like), some of which may be used to obtain position-related measurements and/or other information.

Embodiments of the UE 1200 may also include a Global Navigation Satellite System (GNSS) receiver 1280 capable of receiving signals 1284 from one or more GNSS satellites using an antenna 1282 (which could be the same as antenna 1232). Positioning based on GNSS signal measurement can be utilized to complement and/or incorporate the techniques described herein. The GNSS receiver 1280 can extract a position of the UE 1200, using conventional techniques, from GNSS satellites of a GNSS system, such as Global Positioning System (GPS), Galileo, GLONASS, Quasi-Zenith Satellite System (QZSS) over Japan, IRNSS over India, BeiDou Navigation Satellite System (BDS) over China, and/or the like. Moreover, the GNSS receiver 1280 can be used with various augmentation systems (e.g., a Satellite Based Augmentation System (SBAS)) that may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

It can be noted that, although GNSS receiver 1280 is illustrated in FIG. 12 as a distinct component, embodiments are not so limited. As used herein, the term “GNSS receiver” may comprise hardware and/or software components configured to obtain GNSS measurements (measurements from GNSS satellites). In some embodiments, therefore, the GNSS receiver may comprise a measurement engine executed (as software) by one or more processors, such as processor(s) 1210, DSP 1220, and/or a processor within the wireless communication interface 1230 (e.g., in a modem). A GNSS receiver may optionally also include a positioning engine, which can use GNSS measurements from the measurement engine to determine a position of the GNSS receiver using an Extended Kalman Filter (EKF), Weighted Least Squares (WLS), particle filter, or the like. The positioning engine may also be executed by one or more processors, such as processor(s) 1210 or DSP 1220.

The UE 1200 may further include and/or be in communication with a memory 1260. The memory 1260 can include, without limitation, local and/or network accessible storage, a disk drive, a drive array, an optical storage device, a solid-state storage device, such as a random access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 1260 of the UE 1200 also can comprise software elements (not shown in FIG. 12), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 1260 that are executable by the UE 1200 (and/or processor(s) 1210 or DSP 1220 within UE 1200). In some embodiments, then, such code and/or instructions can be used to configure and/or adapt a general-purpose computer (or other device) to perform one or more operations in accordance with the described methods.

FIG. 13 is a block diagram of an embodiment of a computer system 1300, which may be used, in whole or in part, to provide the functions of one or more network components as described in the embodiments herein, such as one or both of LMF 220 of FIG. 2 and LMF 820 of FIGS. 8 and 10. In some examples, computer system 1300 can perform one or more operations associated with sidelink positioning method of FIG. 11. It should be noted that FIG. 13 is meant only to provide a generalized illustration of various components, any or all of which may be utilized as appropriate. FIG. 13, therefore, broadly illustrates how individual system elements may be implemented in a relatively separated or relatively more integrated manner. In addition, it can be noted that components illustrated by FIG. 13 can be localized to a single device and/or distributed among various networked devices, which may be disposed at different geographical locations.

The computer system 1300 is shown comprising hardware elements that can be electrically coupled via a bus 1305 (or may otherwise be in communication, as appropriate). The hardware elements may include processor(s) 1310, which may comprise without limitation one or more general-purpose processors, one or more special-purpose processors (such as digital signal processing chips, graphics acceleration processors, and/or the like), and/or other processing structure, which can be configured to perform one or more of the methods described herein. The computer system 1300 also may comprise one or more input devices 1315, which may comprise without limitation a mouse, a keyboard, a camera, a microphone, and/or the like; and one or more output devices 1320, which may comprise without limitation a display device, a printer, and/or the like.

The computer system 1300 may further include (and/or be in communication with) one or more non-transitory storage devices 1325, which can comprise, without limitation, local and/or network accessible storage, and/or may comprise, without limitation, a disk drive, a drive array, an optical storage device, a solid-state storage device, such as a RAM and/or ROM, which can be programmable, flash-updateable, and/or the like. Such storage devices may be configured to implement any appropriate data stores, including without limitation, various file systems, database structures, and/or the like. Such data stores may include database(s) and/or other data structures used store and administer messages and/or other information to be sent to one or more devices via hubs, as described herein.

The computer system 1300 may also include a communications subsystem 1330, which may comprise wireless communication technologies managed and controlled by a wireless communication interface 1333, as well as wired technologies (such as Ethernet, coaxial communications, universal serial bus (USB), and the like). The wireless communication interface 1333 may comprise one or more wireless transceivers that may send and receive wireless signals 1355 (e.g., signals according to 5G NR or LTE) via wireless antenna(s) 1350. Thus the communications subsystem 1330 may comprise a modem, a network card (wireless or wired), an infrared communication device, a wireless communication device, and/or a chipset, and/or the like, which may enable the computer system 1300 to communicate on any or all of the communication networks described herein to any device on the respective network, including a User Equipment (UE), base stations and/or other TRPs, and/or any other electronic devices described herein. Hence, the communications subsystem 1330 may be used to receive and send data as described in the embodiments herein.

In many embodiments, the computer system 1300 will further comprise a working memory 1335, which may comprise a RAM or ROM device, as described above. Software elements, shown as being located within the working memory 1335, may comprise an operating system 1340, device drivers, executable libraries, and/or other code, such as one or more applications 1345, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the storage device(s) 1325 described above. In some cases, the storage medium might be incorporated within a computer system, such as computer system 1300. In other embodiments, the storage medium might be separate from a computer system (e.g., a removable medium, such as an optical disc), and/or provided in an installation package, such that the storage medium can be used to program, configure, and/or adapt a general purpose computer with the instructions/code stored thereon. These instructions might take the form of executable code, which is executable by the computer system 1300 and/or might take the form of source and/or installable code, which, upon compilation and/or installation on the computer system 1300 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processors and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description embodiments may include different combinations of features. Implementation examples are described in the following numbered clauses:

Clause 1. A sidelink positioning method, including selecting a set of anchor user equipments (UEs) for a sidelink positioning of a target UE, determining that the set of anchor UEs is collinear, and responsive to the determination that the set of anchor UEs is collinear, initiating a collinear anchor positioning procedure including determining an estimated location of the target UE based on positioning measurements associated with the set of anchor UEs, generating a location report including the estimated location of the target UE, where the location report includes an indication that the estimated location is based on collinear anchor positioning measurements, and providing the location report to a location requesting entity.

Clause 2. The sidelink positioning method of clause 1, where the location report indicates a lateral uncertainty associated with the estimated location of the target UE.

Clause 3. The sidelink positioning method of any of clauses 1 to 2, where the location report indicates a relative orientation of a lateral dimension associated with the estimated location of the target UE.

Clause 4. The sidelink positioning method of any of clauses 1 to 3, where determining that the set of anchor UEs is collinear includes determining a value of a collinearity metric for the set of anchor UEs, and determining that the set of anchor UEs is collinear based on the value of the collinearity metric.

Clause 5. The sidelink positioning method of clause 4, where determining that the set of anchor UEs is collinear includes determining that the set of anchor UEs is collinear based on a comparison of the value of the collinearity metric with a threshold.

Clause 6. The sidelink positioning method of any of clauses 4 to 5, where determining the value of the collinearity metric includes determining the value of the collinearity metric based on anchor location information indicating respective locations of the set of anchor UEs.

Clause 7. The sidelink positioning method of clause 6, further including receiving the anchor location information from the target UE.

Clause 8. The sidelink positioning method of any of clauses 1 to 7, where selecting the set of anchor UEs includes identifying a plurality of candidate anchor UEs for the sidelink positioning of the target UE, and selecting the set of anchor UEs from among the plurality of candidate anchor UEs.

Clause 9. The sidelink positioning method of any of clauses 1 to 8, where the collinear anchor positioning procedure further includes requesting supplemental positioning measurements associated with one or more of the set of anchor UEs, and determining the estimated location of the target UE based on the positioning measurements associated with the set of anchor UEs and the supplemental positioning measurements associated with the one or more of the set of anchor UEs.

Clause 10. The sidelink positioning method of any of clauses 1 to 9, where one or more anchor UEs of the set of anchor UEs are roadside units (RSUs).

Clause 11. The sidelink positioning method of any of clauses 1 to 10, where the positioning measurements associated with the set of anchor UEs include round-trip time (RTT) measurements.

Clause 12. The sidelink positioning method of any of clauses 1 to 11, where the positioning measurements associated with the set of anchor UEs include time difference of arrival (TDoA) measurements.

Clause 13. An apparatus for sidelink positioning, including at least one processor, and at least one memory communicatively coupled with the at least one processor and storing processor-readable code that, when executed by the at least one processor, is configured to select a set of anchor user equipments (UEs) for a sidelink positioning of a target UE, determine that the set of anchor UEs is collinear, and responsive to the determination that the set of anchor UEs is collinear, initiate a collinear anchor positioning procedure including determining an estimated location of the target UE based on positioning measurements associated with the set of anchor UEs, generating a location report including the estimated location of the target UE, where the location report includes an indication that the estimated location is based on collinear anchor positioning measurements, and providing the location report to a location requesting entity.

Clause 14. The apparatus of clause 13, where the location report indicates a lateral uncertainty associated with the estimated location of the target UE.

Clause 15. The apparatus of any of clauses 13 to 14, where the location report indicates a relative orientation of a lateral dimension associated with the estimated location of the target UE.

Clause 16. The apparatus of any of clauses 13 to 15, where the at least one memory stores processor-readable code that, to determine that the set of anchor UEs is collinear, when executed by the at least one processor, is configured to determine a value of a collinearity metric for the set of anchor UEs, and determine that the set of anchor UEs is collinear based on the value of the collinearity metric.

Clause 17. The apparatus of clause 16, where the at least one memory stores processor-readable code that, to determine that the set of anchor UEs is collinear, when executed by the at least one processor, is configured to determine that the set of anchor UEs is collinear based on a comparison of the value of the collinearity metric with a threshold.

Clause 18. The apparatus of any of clauses 16 to 17, where the at least one memory stores processor-readable code that, to determine the value of the collinearity metric, when executed by the at least one processor, is configured to determine the value of the collinearity metric based on anchor location information indicating respective locations of the set of anchor UEs.

Clause 19. The apparatus of clause 18, where the at least one memory stores processor-readable code that, when executed by the at least one processor, is configured to receive the anchor location information from the target UE.

Clause 20. The apparatus of any of clauses 13 to 19, where the at least one memory stores processor-readable code that, to select the set of anchor UEs, when executed by the at least one processor, is configured to identify a plurality of candidate anchor UEs for the sidelink positioning of the target UE, and select the set of anchor UEs from among the plurality of candidate anchor UEs.

Clause 21. The apparatus of any of clauses 13 to 20, where the collinear anchor positioning procedure further includes requesting supplemental positioning measurements associated with one or more of the set of anchor UEs, and determining the estimated location of the target UE based on the positioning measurements associated with the set of anchor UEs and the supplemental positioning measurements associated with the one or more of the set of anchor UEs.

Clause 22. The apparatus of any of clauses 13 to 21, where one or more anchor UEs of the set of anchor UEs are roadside units (RSUs).

Clause 23. The apparatus of any of clauses 13 to 22, where the positioning measurements associated with the set of anchor UEs include round-trip time (RTT) measurements.

Clause 24. The apparatus of any of clauses 13 to 23, where the positioning measurements associated with the set of anchor UEs include time difference of arrival (TDoA) measurements.

Clause 25. An apparatus for sidelink positioning, including means for selecting a set of anchor user equipments (UEs) for a sidelink positioning of a target UE, means for determining that the set of anchor UEs is collinear, and means for, responsive to the determination that the set of anchor UEs is collinear, initiating a collinear anchor positioning procedure including determining an estimated location of the target UE based on positioning measurements associated with the set of anchor UEs, generating a location report including the estimated location of the target UE, where the location report includes an indication that the estimated location is based on collinear anchor positioning measurements, and providing the location report to a location requesting entity.

Clause 26. The apparatus of clause 25, where the location report indicates a lateral uncertainty associated with the estimated location of the target UE.

Clause 27. The apparatus of any of clauses 25 to 26, where the location report indicates a relative orientation of a lateral dimension associated with the estimated location of the target UE.

Clause 28. The apparatus of any of clauses 25 to 27, where the means for determining that the set of anchor UEs is collinear includes means for determining a value of a collinearity metric for the set of anchor UEs, and means for determining that the set of anchor UEs is collinear based on the value of the collinearity metric.

Clause 29. The apparatus of clause 28, where the means for determining that the set of anchor UEs is collinear includes means for determining that the set of anchor UEs is collinear based on a comparison of the value of the collinearity metric with a threshold.

Clause 30. The apparatus of any of clauses 28 to 29, where the means for determining the value of the collinearity metric includes means for determining the value of the collinearity metric based on anchor location information indicating respective locations of the set of anchor UEs.

Clause 31. The apparatus of clause 30, including means for receiving the anchor location information from the target UE.

Clause 32. The apparatus of any of clauses 25 to 31, where the means for selecting the set of anchor UEs includes means for identifying a plurality of candidate anchor UEs for the sidelink positioning of the target UE, and means for selecting the set of anchor UEs from among the plurality of candidate anchor UEs.

Clause 33. The apparatus of any of clauses 25 to 32, where the collinear anchor positioning procedure further includes requesting supplemental positioning measurements associated with one or more of the set of anchor UEs, and determining the estimated location of the target UE based on the positioning measurements associated with the set of anchor UEs and the supplemental positioning measurements associated with the one or more of the set of anchor UEs.

Clause 34. The apparatus of any of clauses 25 to 33, where one or more anchor UEs of the set of anchor UEs are roadside units (RSUs).

Clause 35. The apparatus of any of clauses 25 to 34, where the positioning measurements associated with the set of anchor UEs include round-trip time (RTT) measurements.

Clause 36. The apparatus of any of clauses 25 to 35, where the positioning measurements associated with the set of anchor UEs include time difference of arrival (TDoA) measurements.

Clause 37. A non-transitory computer-readable medium storing instructions for sidelink positioning, the instructions including code to select a set of anchor user equipments (UEs) for a sidelink positioning of a target UE, determine that the set of anchor UEs is collinear, and responsive to the determination that the set of anchor UEs is collinear, initiate a collinear anchor positioning procedure including determining an estimated location of the target UE based on positioning measurements associated with the set of anchor UEs, generating a location report including the estimated location of the target UE, where the location report includes an indication that the estimated location is based on collinear anchor positioning measurements, and providing the location report to a location requesting entity.

Clause 38. The non-transitory computer-readable medium of clause 37, where the location report indicates a lateral uncertainty associated with the estimated location of the target UE.

Clause 39. The non-transitory computer-readable medium of any of clauses 37 to 38, where the location report indicates a relative orientation of a lateral dimension associated with the estimated location of the target UE.

Clause 40. The non-transitory computer-readable medium of any of clauses 37 to 39, the instructions including code to determine a value of a collinearity metric for the set of anchor UEs, and determine that the set of anchor UEs is collinear based on the value of the collinearity metric.

Clause 41. The non-transitory computer-readable medium of clause 40, the instructions including code to determine that the set of anchor UEs is collinear based on a comparison of the value of the collinearity metric with a threshold.

Clause 42. The non-transitory computer-readable medium of any of clauses 40 to 41, the instructions including code to determine the value of the collinearity metric based on anchor location information indicating respective locations of the set of anchor UEs.

Clause 43. The non-transitory computer-readable medium of clause 42, the instructions including code to receive the anchor location information from the target UE.

Clause 44. The non-transitory computer-readable medium of any of clauses 37 to 43, the instructions including code to identify a plurality of candidate anchor UEs for the sidelink positioning of the target UE, and select the set of anchor UEs from among the plurality of candidate anchor UEs.

Clause 45. The non-transitory computer-readable medium of any of clauses 37 to 44, where the collinear anchor positioning procedure further includes requesting supplemental positioning measurements associated with one or more of the set of anchor UEs, and determining the estimated location of the target UE based on the positioning measurements associated with the set of anchor UEs and the supplemental positioning measurements associated with the one or more of the set of anchor UEs.

Clause 46. The non-transitory computer-readable medium of any of clauses 37 to 45, where the anchor UEs of the set of anchor UEs are roadside units (RSUs).

Clause 47. The non-transitory computer-readable medium of any of clauses 37 to 46, where the positioning measurements associated with the set of anchor UEs include round-trip time (RTT) measurements.

Clause 48. The non-transitory computer-readable medium of any of clauses 37 to 47, where the positioning measurements associated with the set of anchor UEs include time difference of arrival (TDoA) measurements.

What is claimed is:

1. A sidelink positioning method, comprising:
selecting a set of anchor user equipments (UEs) for a sidelink positioning of a target UE;
determining that the set of anchor UEs is collinear; and
responsive to the determination that the set of anchor UEs is collinear, initiating a collinear anchor positioning procedure including:
determining an estimated location of the target UE based on positioning measurements associated with the set of anchor UEs;
generating a location report including the estimated location of the target UE, wherein the location report includes an indication that the estimated location is based on collinear anchor positioning measurements; and
providing the location report to a location requesting entity.

2. The sidelink positioning method of claim 1, wherein the location report indicates a lateral uncertainty associated with the estimated location of the target UE.

3. The sidelink positioning method of claim 1, wherein the location report indicates a relative orientation of a lateral dimension associated with the estimated location of the target UE.

4. The sidelink positioning method of claim 1, wherein determining that the set of anchors UE is collinear comprises:
determining a value of a collinearity metric for the set of anchor UEs; and
determining that the set of anchor UEs is collinear based on the value of the collinearity metric.

5. The sidelink positioning method of claim 4, wherein determining that the set of anchors UE is collinear comprises determining that the set of anchor UEs is collinear based on a comparison of the value of the collinearity metric with a threshold.

6. The sidelink positioning method of claim 4, wherein determining the value of the collinearity metric comprises determining the value of the collinearity metric based on anchor location information indicating respective locations of the set of anchor UEs.

7. The sidelink positioning method of claim 6, further comprising receiving the anchor location information from the target UE.

8. The sidelink positioning method of claim 1, wherein selecting the set of anchor UEs comprises:
identifying a plurality of candidate anchor UEs for the sidelink positioning of the target UE; and
selecting the set of anchor UEs from among the plurality of candidate anchor UEs.

9. The sidelink positioning method of claim 1, wherein the collinear anchor positioning procedure further comprises:
requesting supplemental positioning measurements associated with one or more of the set of anchor UEs; and
determining the estimated location of the target UE based on the positioning measurements associated with the set of anchor UEs and the supplemental positioning measurements associated with the one or more of the set of anchor UEs.

10. The sidelink positioning method of claim 1, wherein one or more anchor UEs of the set of anchor UEs are roadside units (RSUs).

11. The sidelink positioning method of claim 1, wherein the positioning measurements associated with the set of anchor UEs comprise round-trip time (RTT) measurements.

12. The sidelink positioning method of claim 1, wherein the positioning measurements associated with the set of anchor UEs comprise time difference of arrival (TDoA) measurements.

13. An apparatus for sidelink positioning, comprising:
at least one processor; and
at least one memory communicatively coupled with the at least one processor and storing processor-readable code that, when executed by the at least one processor, is configured to:
select a set of anchor user equipments (UEs) for a sidelink positioning of a target UE;
determine that the set of anchor UEs is collinear; and
responsive to the determination that the set of anchor UEs is collinear, initiate a collinear anchor positioning procedure including:
determining an estimated location of the target UE based on positioning measurements associated with the set of anchor UEs;
generating a location report including the estimated location of the target UE, wherein the location report includes an indication that the estimated location is based on collinear anchor positioning measurements; and
providing the location report to a location requesting entity.

14. The apparatus of claim 13, wherein the location report indicates a lateral uncertainty associated with the estimated location of the target UE.

15. The apparatus of claim 13, wherein the location report indicates a relative orientation of a lateral dimension associated with the estimated location of the target UE.

16. The apparatus of claim 13, wherein the at least one memory stores processor-readable code that, to determine that the set of anchor UEs is collinear, when executed by the at least one processor, is configured to:
determine a value of a collinearity metric for the set of anchor UEs; and
determine that the set of anchor UEs is collinear based on the value of the collinearity metric.

17. The apparatus of claim 16, wherein the at least one memory stores processor-readable code that, to determine that the set of anchor UEs is collinear, when executed by the at least one processor, is configured to determine that the set of anchor UEs is collinear based on a comparison of the value of the collinearity metric with a threshold.

18. The apparatus of claim 16, wherein the at least one memory stores processor-readable code that, to determine the value of the collinearity metric, when executed by the at least one processor, is configured to determine the value of the collinearity metric based on anchor location information indicating respective locations of the set of anchor UEs.

19. The apparatus of claim 18, wherein the at least one memory stores processor-readable code that, when executed by the at least one processor, is configured to receive the anchor location information from the target UE.

20. The apparatus of claim 13, wherein the at least one memory stores processor-readable code that, to select the set of anchor UEs, when executed by the at least one processor, is configured to:
identify a plurality of candidate anchor UEs for the sidelink positioning of the target UE; and
select the set of anchor UEs from among the plurality of candidate anchor UEs.

21. The apparatus of claim 13, wherein the collinear anchor positioning procedure further comprises:
requesting supplemental positioning measurements associated with one or more of the set of anchor UEs; and
determining the estimated location of the target UE based on the positioning measurements associated with the set of anchor UEs and the supplemental positioning measurements associated with the one or more of the set of anchor UEs.

22. The apparatus of claim 13, wherein one or more anchor UEs of the set of anchor UEs are roadside units (RSUs).

23. The apparatus of claim 13, wherein the positioning measurements associated with the set of anchor UEs comprise round-trip time (RTT) measurements.

24. The apparatus of claim 13, wherein the positioning measurements associated with the set of anchor UEs comprise time difference of arrival (TDoA) measurements.

25. An apparatus for sidelink positioning, comprising:
means for selecting a set of anchor user equipments (UEs) for a sidelink positioning of a target UE;
means for determining that the set of anchor UEs is collinear; and
means for initiating a collinear anchor positioning procedure responsive to the determination that the set of anchor UEs is collinear, the collinear anchor positioning procedure including:
determining an estimated location of the target UE based on positioning measurements associated with the set of anchor UEs;
generating a location report including the estimated location of the target UE, wherein the location report includes an indication that the estimated location is based on collinear anchor positioning measurements; and
providing the location report to a location requesting entity.

26. The apparatus of claim 25, wherein the location report indicates a lateral uncertainty associated with the estimated location of the target UE.

27. The apparatus of claim 25, wherein the location report indicates a relative orientation of a lateral dimension associated with the estimated location of the target UE.

28. A non-transitory computer-readable medium storing instructions for sidelink positioning, the instructions including code to:
select a set of anchor user equipments (UEs) for a sidelink positioning of a target UE;
determine that the set of anchor UEs is collinear; and
responsive to the determination that the set of anchor UEs is collinear, initiate a collinear anchor positioning procedure including:
determining an estimated location of the target UE based on positioning measurements associated with the set of anchor UEs;
generating a location report including the estimated location of the target UE, where the location report includes an indication that the estimated location is based on collinear anchor positioning measurements; and
providing the location report to a location requesting entity.

29. The non-transitory computer-readable medium of claim 28, wherein the location report indicates a lateral uncertainty associated with the estimated location of the target UE.

30. The non-transitory computer-readable medium of claim 28, wherein the location report indicates a relative orientation of a lateral dimension associated with the estimated location of the target UE.
